(19) United States
(12) Patent Application Publication
(10) Pub. No.: US 2025/0222916 A1
(43) Pub. Date: Jul. 10, 2025

(54) SYSTEMS AND METHODS FOR DRIVE MODE CONTROL

(71) Applicant: Ford Global Technologies, LLC, Dearborn, MI (US)

(72) Inventors: Dominique Meroux, San Francisco, CA (US); Kai Wu, Pittsburgh, PA (US); Chen Zhang, South Lyon, MI (US)

(21) Appl. No.: 18/409,568

(22) Filed: Jan. 10, 2024

(51) Int. Cl. B60W 20/12; B60W 10/06; B60W 20/13; B60W 20/16; G01C 21/34; G01C 21/36; G07C 5/02

(52) U.S. Cl. CPC B60W 20/12; B60W 10/06; B60W 20/13; G01C 21/3469; G01C 21/3679; B60W 20/16; B60W 2555/20; B60W 2710/06; B60W 2710/244; G07C 5/02

(57) ABSTRACT

Methods and systems are provided for selectively controlling hybrid drive modes of a hybrid vehicle to reduce emissions. In one example, a method may include using route planning and vehicle operating conditions to identify emissions reducing opportunities. In one example, in response to a route distance not exceeding an electric range, the method includes suppressing an operation of an engine based on the route data, ambient temperature, and cabin pre-conditioning. In response to the route distance exceeding the electric range, further in anticipation of a fuel station along the route, where the fuel station has a fuel with a carbon footprint less than a low carbon threshold, the method includes operating the hybrid vehicle in a charge sustaining or charge increasing mode prior to a refueling event at the fuel station.

### FIELD

The present description relates generally to methods and systems for controlling hybrid vehicle operation to reduce emissions.

### BACKGROUND/SUMMARY

Plug in hybrid electric vehicles (PHEV) are hybrid vehicles with a battery pack and an internal combustion engine, where the battery pack is capable of being charged by both an external charging station and a generator powered by the internal combustion engine. PHEVs may drive in an all-electric mode using electricity stored on the battery or drive powered by the internal combustion engine when the battery is depleted. The capability of PHEVs to run fully off of electric power without starting the liquid fuel powered engine gives them the potential to significantly reduce tail pipe emissions. However, a growing body of literature suggests PHEV all-electric share of total driving, or utility factor (UF), is lower than initial policymaker assumptions, while engine starts are higher. A lower all-electric share of driving than expected may result in higher emissions.

There are multiple potential culprits for this shortcoming. One issue PHEV owners may face is lack of access to charging stations. Apartment dwellers may find that neither their building nor their workplace has any electric vehicle charging stations. If such a person wants to run their PHEV on fully electric power, the person may rely on public charging stations. Drivers may have difficulty locating convenient AC chargers and adjusting their schedule to account for the time it can take to charge a vehicle fully. Another potential source of lower UF than expected is user control of the multiple drive modes. Plug in hybrids offer multiple drive modes, including PHEV-specific modes like force charge sustain or force charge deplete, as well as potentially various vehicle drive modes centered on performance or efficiency. The downside is a potential gap between the engineered intention and customer understanding of when to apply various modes, and what benefit is achieved. A driver might also struggle to understand the advantages and uses of the multiple drive modes offered by the vehicle. Selecting the wrong drive mode, or changing the drive mode accidentally can lead to unintentional engine start events. For example, this can occur if a driver accidentally selects a drive mode that requires an engine start, but quickly changes their selection to an all-electric driving mode.

Other attempts to address emissions from PHEV include methods for identifying charging stations near a driver's route, or the emissions associated with fuel sources. For example, Kim in US 2023/0015077 A1 teaches an approach for estimating a potential carbon footprint of driving a vehicle in real-time including displaying estimated carbon footprints for various refueling or recharging sites along a route. The approach takes into account the primary source of the refueling or recharging site, including emissions from upstream processes prior to the vehicle's energy consumption. Another approach is shown by O'Connell et al. in U.S. Pat. No. 10,245,968 B2. Therein, a system is described to select the operating mode of a PHEV based upon a number of environmental factors. These factors include the planned travel route, the elevation of the car, the locations of charging and fuel stations near the route and the primary source of the power being supplied to the vehicle. In this case, the primary source of the power is considered when selecting the operating mode of the vehicle. For example, in an area where grid electricity is generated by a local coal plant, liquid fuel may be prioritized to reduce the emissions produced by burning coal.

However, the inventors herein have recognized potential issues with such systems. As one example, vehicle operating conditions may interfere with opportunities reduce emissions. For example, a vehicle with a full, low-emission electric charge may increase emissions during unintended engine starts, such as caused by a cabin conditioning request or drive mode selection. As another example, local conditions may constrain vehicle operation, such as localized legislation on tailpipe emissions. Lack of planning for low emission fueling and/or low emission charging usage around such corridors may unintentionally increase emissions. As another example, during a drive that exceeds the range of the battery, drive mode control strategies that prioritize electric-only operation may prevent a PHEV from taking full advantage of low emission refueling opportunities. Conversely, during trips that do not exceed the range, opportunities to recharge at low emission recharging stations may be missed. Missed opportunities for low emission recharging during a trip may be especially relevant to PHEV owners without home-charging.

In one example, the issues described above may be addressed by a method for a hybrid vehicle. The method includes receiving route data comprising a destination and a route, and determining a route distance based on the route data. In response to the route distance not exceeding an electric range, the method includes suppressing an operation of an engine based on the route data, ambient temperature, and cabin pre-conditioning. In response to the route distance exceeding the electric range, further in anticipation of a fuel station along the route, where the fuel station has a fuel with a carbon footprint less than a low carbon threshold, the method includes operating the hybrid vehicle in a charge sustaining mode or charge increasing mode prior to a refueling event at the fuel station. In this way, the method prioritizes low emission energy, and simplifies the operation of the vehicle to reduce engine starts.

As one example, a driver may input their destination into an electronic device that is connected to the vehicle's computing systems. A route may be computed, including the distance the route covers. This distance may be compared to the range of the electric vehicle at the current state of charge. Fuel stations and electric vehicle charging stations may also be identified along the route. Under some conditions, the driver may be presented ranked options for refueling and recharging their vehicle, with opportunities having the lowest carbon footprint or overall emissions preferred. The trip itinerary can then be adjusted to accommodate refueling or recharging, including adjusting the drive mode of the car to match the trip itinerary and conditions. For example, the vehicle may operate in a fuel-using drive mode, such as the charge sustaining mode or the charge increasing mode, so that a greater amount of low carbon fuel may be added to the fuel tank during the refueling event on the trip itinerary. To account for the time it takes to recharge the vehicle, an associated experience may be suggested to accompany electric charging ports. For example, the proposed itinerary might suggest the driver get coffee for an hour at a shop near the charging station so the vehicle can charge. In this way, the drive mode of the vehicle is controlled to prioritize reducing overall emissions.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a plug-in hybrid vehicle system.

FIG. 2 is an example plug-in hybrid energy management strategy.

FIG. 3 is a look up table for the example plug-in hybrid energy management strategy of FIG. 2.

FIG. 4 is plot depicting energy management strategies for the plug-in hybrid energy management system of FIG. 2.

FIG. 5A is a first flow chart illustrating a first method for selective drive mode operation and route planning for emission reduction.

FIG. 5B is a second flow chart illustrating the first method for selective drive mode operation and route planning for emission reduction.

FIG. 6 is a third flow chart illustrating a third method for suggesting low carbon fuel stations along a route.

FIG. 7 is a diagram illustrating a logic for suggesting low carbon fuel stations along a route based on various driving scenarios.

### DETAILED DESCRIPTION

The following description relates to systems and methods for plug in hybrid vehicle (PHEV) emission reduction, including greenhouse gases such as carbon dioxide. In one example, the method includes receiving an itinerary or driving route plan, including a route distance, which may be input by a manually driver or otherwise obtained. When a planned route does not exceed an electric range of the PHEV, the method includes prioritizing driving in all-electric, charge depleting drive mode, including reducing unintended engine-starts and drive mode switching. When a planned route exceeds the electric range, in anticipation of a low emission refueling opportunity, the method includes operating the vehicle in a fuel-using, charge increasing or charge sustaining drive mode prior to the refueling event. Throughout the trip, opportunities for reducing PHEV emission may be evaluated, the opportunities proposed to the driver, including factors that may influence a driver to take advantage of the opportunities, with drive mode control and vehicle operating conditions leveraged to reduce overall emissions, and maximize low emission refueling and recharging opportunities.

In one example, the charge sustaining mode is a drive mode wherein fuel may be burned to propel the vehicle in order to maintain a state of charge (SOC) of the battery throughout the trip. For example, a vehicle that starts a trip with a 20% SOC may end the trip at a 20% SOC. The charge increasing mode is a drive mode where the fuel is burned to propel the vehicle and increase the SOC of the battery throughout the trip. For example, a vehicle operated in charge increasing mode may begin the trip at a 20% SOC and end the trip with a 30% SOC. The charge sustaining mode may make more efficient use of electric resources in combination with fuel burning and as a result burn less liquid fuel during the trip. Both of the charge increasing and charge sustaining drive modes use liquid fuel, and prioritize liquid fuel use at the beginning of a trip in anticipation of a low-carbon refueling event that allows the fuel used during the charge sustaining or charge increasing modes to be replenished at the refueling station.

In some examples, the method may evaluate charging opportunities based on expected duration parked, compatibility between a charger maximum output power and a capacity of the PHEV, and predicted state of charge (SOC) of the PHEV, and battery capacity. As another example, the method may evaluate local operating conditions such as whether the PHEV operates in a priority region and/or time for local emissions reduction. In some examples, the method may further evaluate opportunities to reduce emissions by coordinating PHEVs and battery electric vehicles (BEVs) within a fleet, apartment, offices, and so on. For example, the method may prioritize drawing energy from the grid during low-emission times, and during high emissions times, present opportunities for the PHEV to draw charge from a BEV in the same fleet. As another example, BEVs and PHEVs in the same fleet, apartment, offices, etc., may coordinate usage of stationary EV chargers to reduce emissions. For example, in a fleet of PHEVs and BEVs, it may be possible to reduce engine start events for a PHEV by drawing charge from a BEV within the same fleet. The charge from the BEV may power the PHEV instead of making use of liquid fuel. As another example, under relevant conditions, BEVs and PHEVs may coordinate with a PHEVs expected trip start for battery and cabin-preconditioning. By prioritizing emission reduction, evaluating opportunities to reduce emissions based on route data, and coordinating with other low emission vehicles, the disclosed systems and methods may meaningfully reduce unintended PHEV emissions.

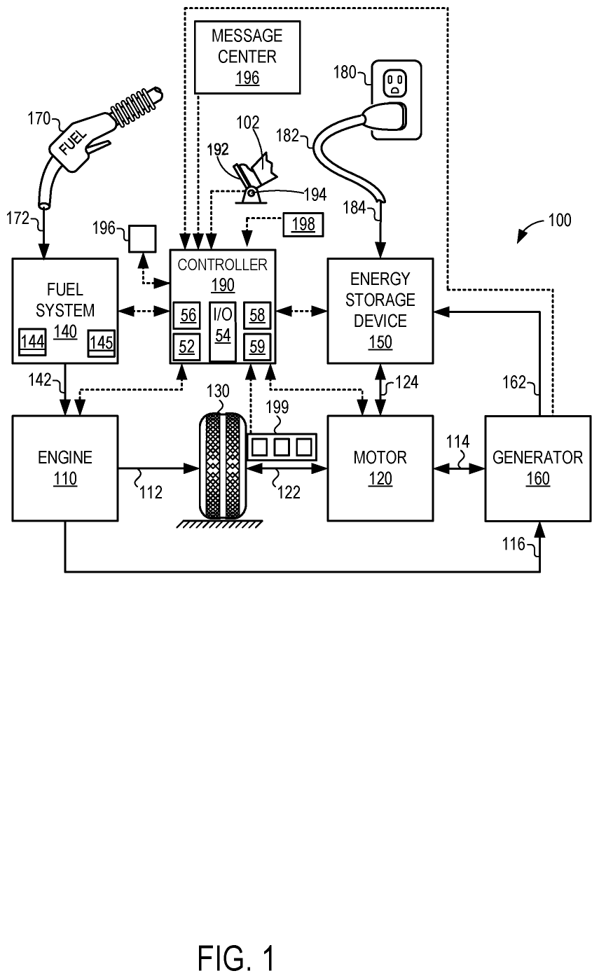

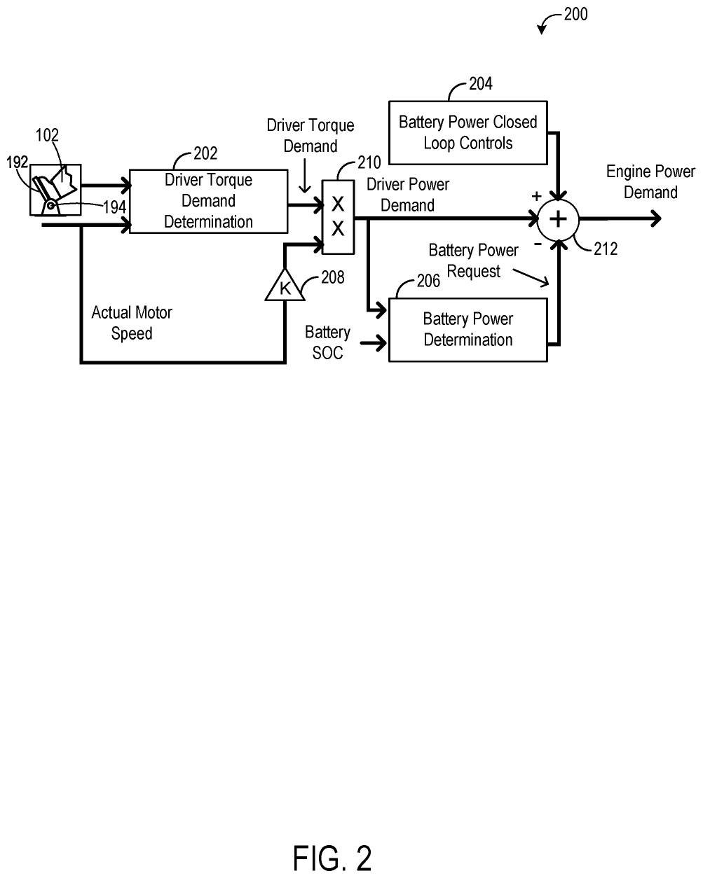

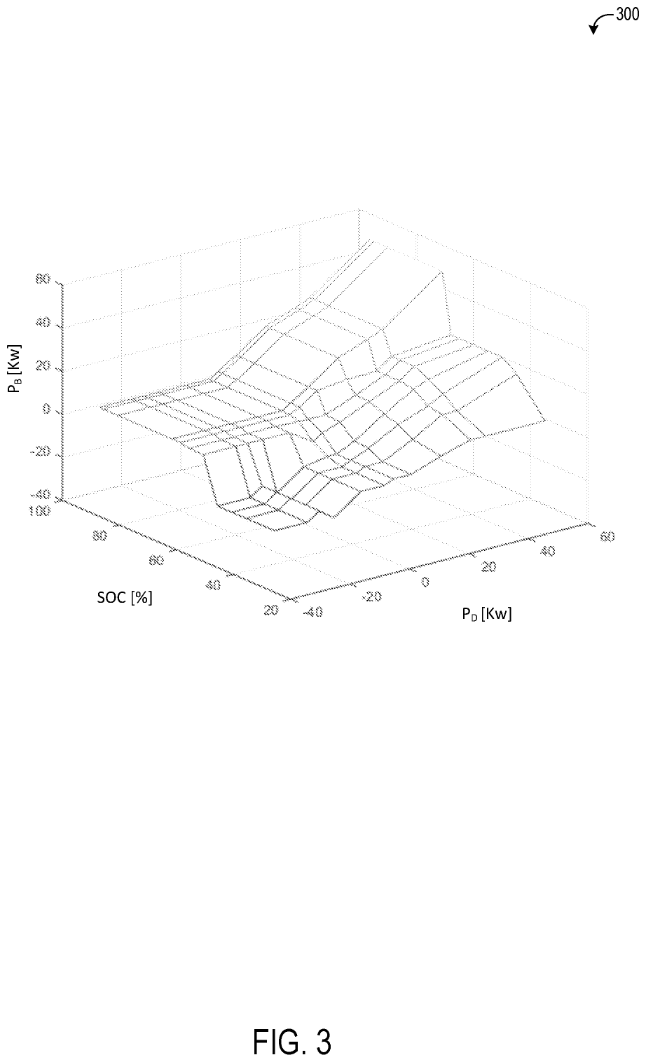

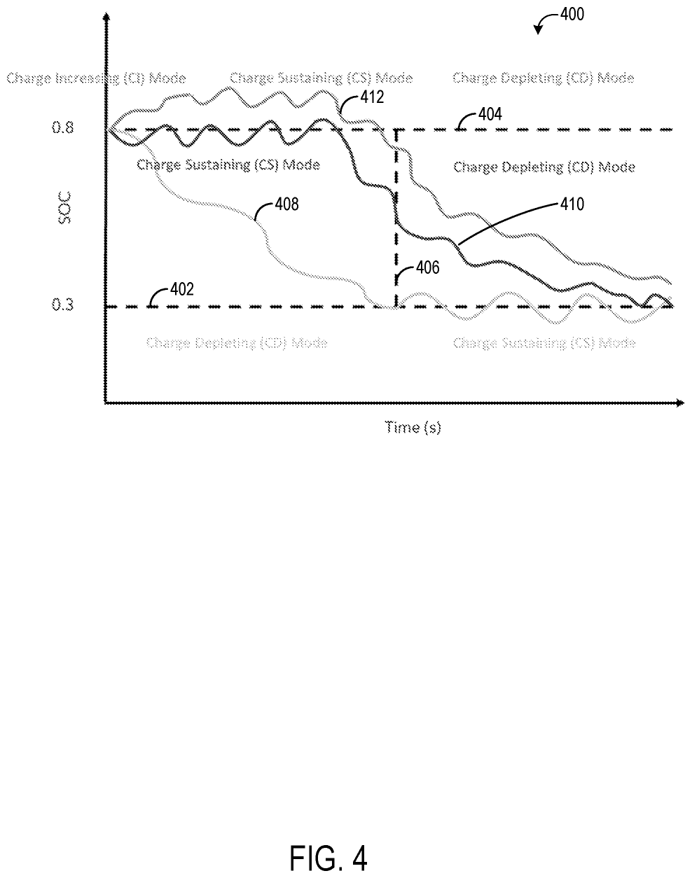

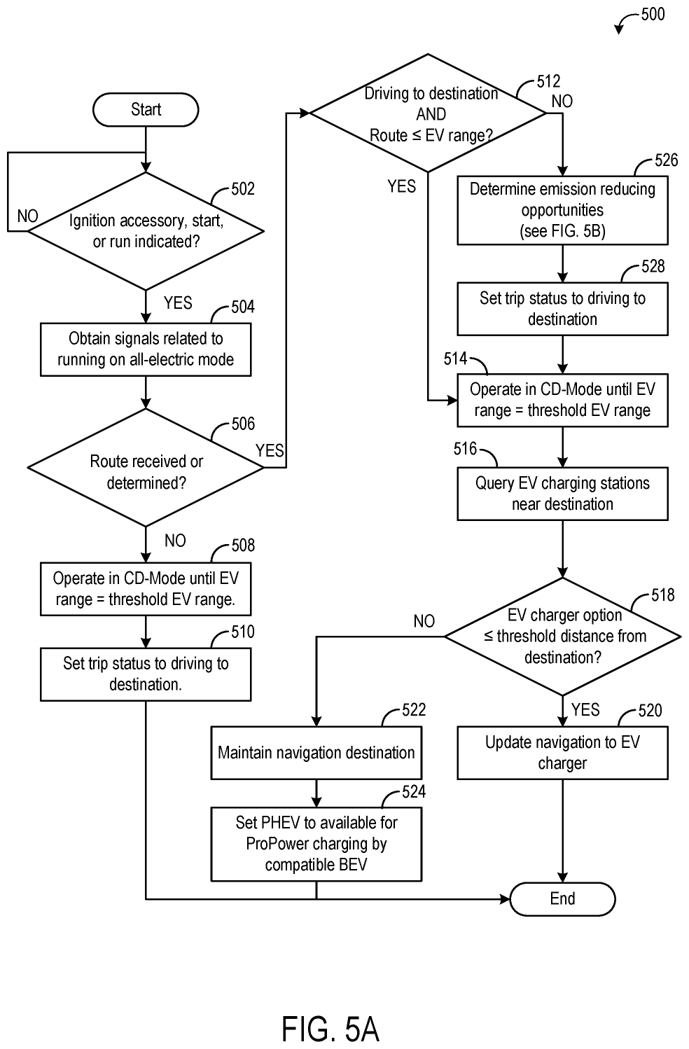

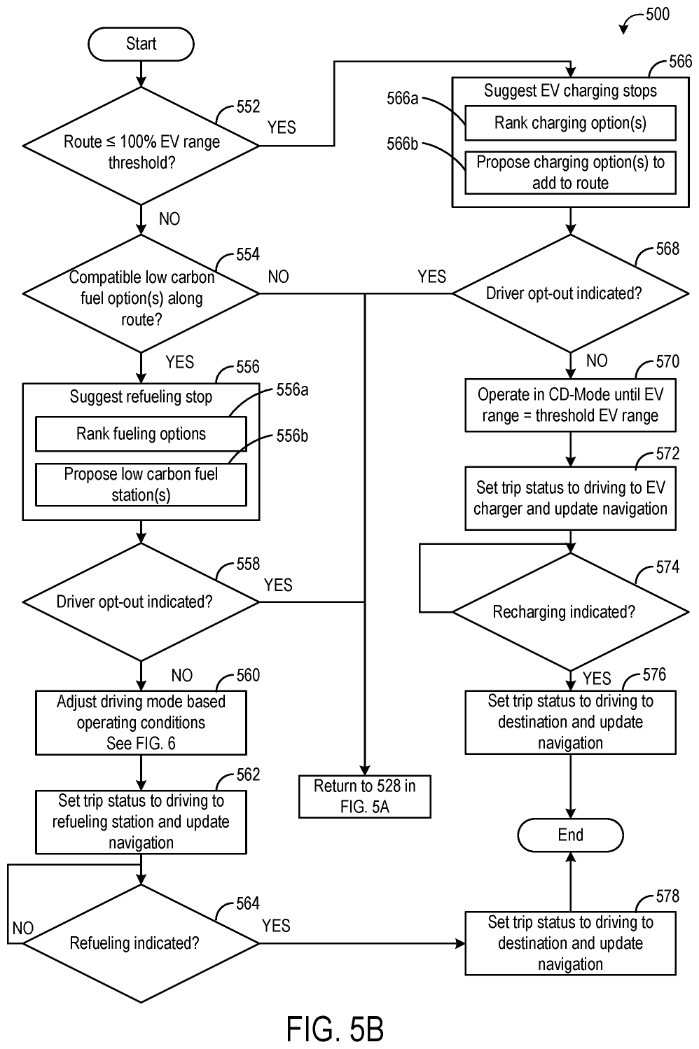

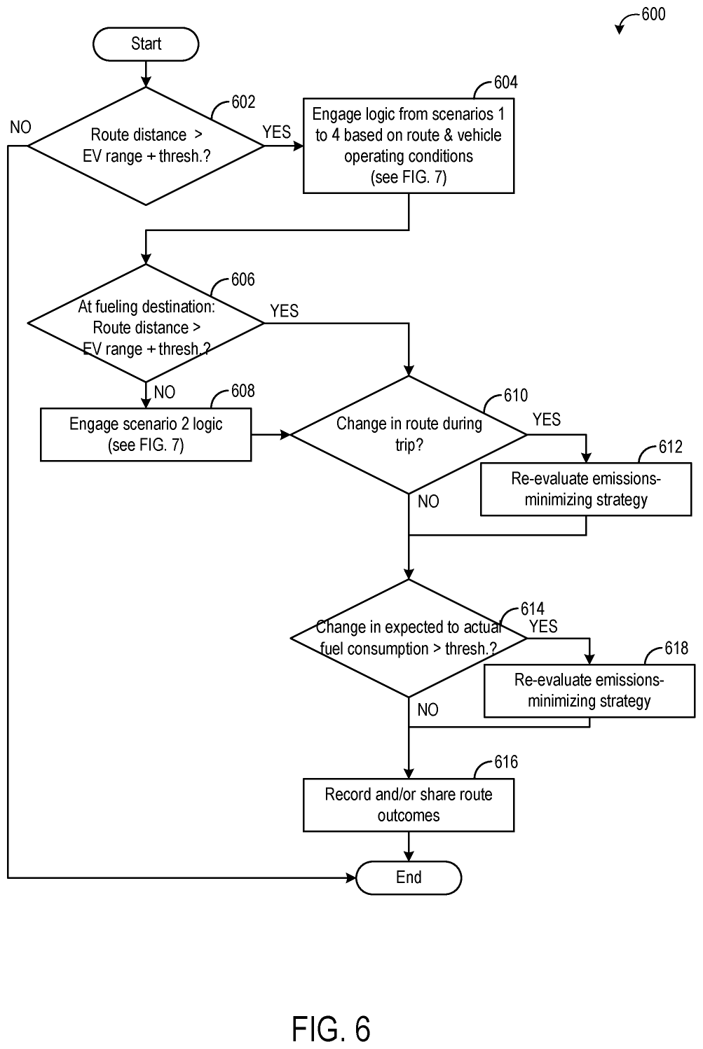

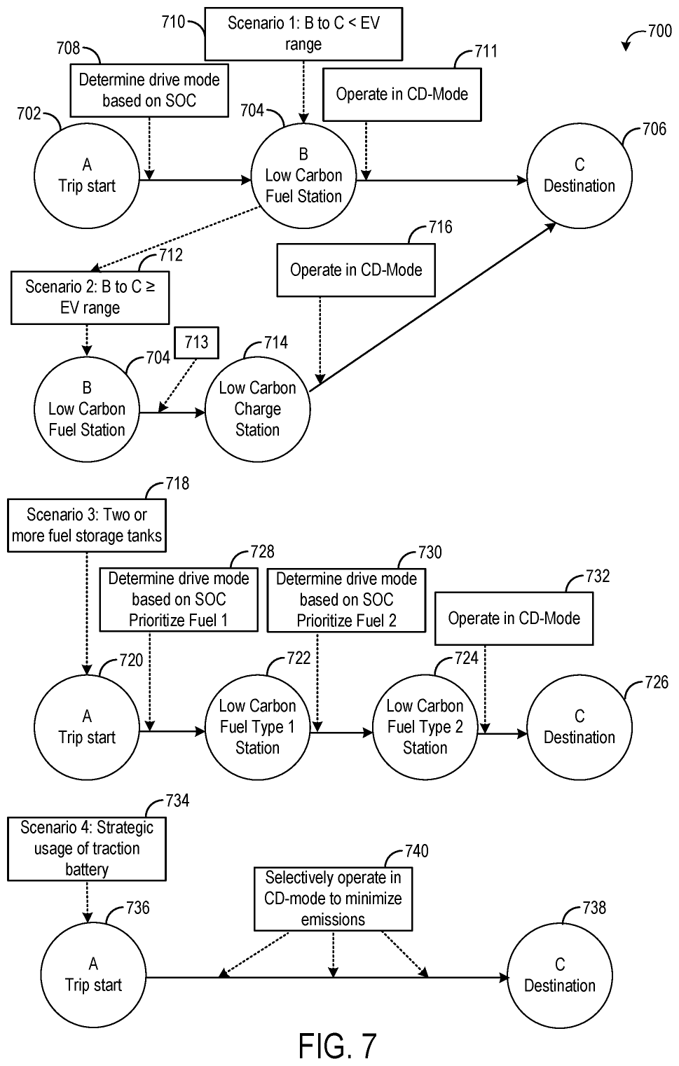

An example plug-in hybrid vehicle system is shown in FIG. 1. FIG. 2 shows an example of an energy management system for a plug-in hybrid vehicle, such as described with reference to FIG. 1. The system may include monitoring a state of the battery, driver torque demand, and a motor speed to determine power contributions of the battery and the engine to provide the torque demand. In this scenario, both the electric motor and engine contribute power to the vehicle. FIG. 3 is a look up table for battery power determination that may be applicable to the power management system described with reference to FIG. 2. FIG. 4 is plot depicting drive mode control strategies for the plug-in hybrid energy management system of FIG. 2. A method including selective drive mode operation and route planning for emission reduction in a plug in hybrid is shown in FIG. 5A and FIG. 5B. The method may include locating and suggesting one or both of low carbon options and recharging options depending on the route distance and vehicle charge state, and vehicle controls to reduce overall emissions on the route. FIG. 6 and FIG. 7 illustrate example logic for suggesting low carbon fuel stations along a route, and maximizing storage of low carbon fuel based on example driving scenarios. The example driving scenarios may include the conditions of the vehicle and the route, and strategies to prioritize reducing emissions based on the conditions.

Turning to FIG. 1, an example vehicle propulsion system 100 is shown. Vehicle propulsion system 100 includes a fuel burning engine 110 and a motor 120. As a non-limiting example, engine 110 comprises an internal combustion engine and motor 120 comprises an electric motor. Motor 120 may be configured to utilize or consume a different energy source than engine 110. For example, engine 110 may consume a liquid fuel (e.g. gasoline) to produce an engine output while motor 120 may consume electrical energy to produce a motor output. As such, a vehicle with propulsion system 100 may be referred to in the present disclosure as a plug in hybrid electric vehicle (PHEV), a hybrid electric vehicle (HEV), or an extended range electric vehicle (eREV). PHEVs, HEVs, and eREVs are non-limiting examples of vehicles that include both a battery and a supplementary propulsion system.

Vehicle propulsion system 100 may utilize a variety of different operational modes depending on operating conditions encountered by the vehicle propulsion system. The different operational modes may include a plurality of driving modes, including driver-selectable modes that adjust vehicle operating conditions for efficiency, performance, emissions reduction, or other driver preferences, as well as hybrid-specific modes related to energy management, which are described in more detail with reference to FIG. 4 and the methods 500-700 in FIGS. 5A-7, respectively. Some of these modes may enable engine 110 to be maintained in an off state (e.g. set to a deactivated state) where combustion of fuel at the engine is discontinued. For example, under select operating conditions, motor 120 may propel the vehicle via drive wheel 130 as indicated by arrow 122 while engine 110 is deactivated.

During other operating conditions, engine 110 may be set to a deactivated state (as described above) while motor 120 may be operated to charge energy storage device 150 such as a battery. For example, motor 120 may receive wheel torque from drive wheel 130 as indicated by arrow 122 where the motor may convert the kinetic energy of the vehicle to electrical energy for storage at energy storage device 150 as indicated by arrow 124. This operation may be referred to as regenerative energy recovery. Thus, motor 120 can provide a generator function in some embodiments. However, in other embodiments, generator 160 may instead receive wheel torque from drive wheel 130, where the generator may convert the kinetic energy of the vehicle to electrical energy for storage at energy storage device 150 as indicated by arrow 162.

During still other operating conditions, engine 110 may be operated by combusting fuel received from fuel system 140 as indicated by arrow 142. For example, engine 110 may be operated to propel the vehicle via drive wheel 130 as indicated by arrow 112 while motor 120 is deactivated. During other operating conditions, both engine 110 and motor 120 may each be operated to propel the vehicle via drive wheel 130 as indicated by arrows 112 and 122, respectively. A configuration where both the engine and the motor may selectively propel the vehicle may be referred to as a parallel type vehicle propulsion system. Note that in some embodiments, motor 120 may propel the vehicle via a first set of drive wheels and engine 110 may propel the vehicle via a second set of drive wheels.

In other embodiments, vehicle propulsion system 100 may be configured as a series type vehicle propulsion system, whereby the engine does not directly propel the drive wheels. Rather, engine 110 may be operated to power the motor 120, which may in turn propel the vehicle via drive wheel 130 as indicated by arrow 122. For example, during select operating conditions, engine 110 may drive generator 160, as indicated by arrow 116, which may in turn supply electrical energy to one or more of motor 120 as indicated by arrow 114 or the energy storage device 150 as indicated by arrow 162. As another example, engine 110 may be operated to drive motor 120 which may in turn provide a generator function to convert the engine output to electrical energy, where the electrical energy may be stored at energy storage device 150 for later use by the motor.

Fuel system 140 may include one or more fuel storage tanks for storing fuel on-board the vehicle. For example, first fuel tank 144 may store one or more liquid fuels, including but not limited to: gasoline, diesel, and alcohol fuels. Second fuel tank may store one or more gaseous fuels, including but not limited to: natural gas in forms such as compressed (CNG), absorbed (ANG), and liquefied (LNG), hydrogen, natural gas, propane, and dimethyl ether (DME). In some embodiments, these fuels may be derived from renewable pathways, such as biogas pathways to produce renewable natural gas (RNG), or renewable pathways to produce hydrogen, propane and DME. In some examples, the fuel may be stored on-board the vehicle as a blend of two or more different fuels. For example, the first fuel tank 144 may be configured to store a blend of gasoline and ethanol (e.g. E10, E85, etc.) or a blend of gasoline and methanol (e.g. M10, M85, etc.), whereby these fuels or fuel blends may be delivered to engine 110 as indicated by arrow 142. Still other suitable fuels or fuel blends may be supplied to engine 110, where they may be combusted at the engine to produce an engine output. The engine output may be utilized to propel the vehicle as indicated by arrow 112 or to recharge energy storage device 150 via motor 120 or generator 160.

In some embodiments, energy storage device 150 may be configured to store electrical energy that may be supplied to other electrical loads residing on-board the vehicle (other than the motor), including cabin heating and air conditioning, engine starting, headlights, cabin audio and video systems, etc. As a non-limiting example, energy storage device 150 may include one or more batteries and/or capacitors.

Vehicle propulsion system 100 includes a controller 190. The controller 190 receives signals from the various sensors of FIG. 1 and employs the various actuators of FIG. 1 to adjust vehicle operation based on the received signals and instructions stored in non-transitory memory of the controller 190. Specifically, the controller 190 is shown in FIG. 1 as a conventional microcomputer including: microprocessor unit 52, input/output ports 54, read-only memory 56, random access memory 58, keep alive memory 59, and a conventional data bus. Controller 190 is configured to receive various signals from sensors coupled to the vehicle propulsion system 100 and send command signals to actuators in components in the vehicle propulsion system 100.

Controller 190 may communicate with one or more of engine 110, motor 120, fuel system 140, energy storage device 150, and generator 160. Controller 190 may receive sensory feedback information from one or more of engine 110, motor 120, fuel system 140, energy storage device 150, and generator 160. Further, controller 190 may send control signals to one or more of engine 110, motor 120, fuel system 140, energy storage device 150, and generator 160 responsive to this sensory feedback. Controller 190 may receive an indication of an operator requested output of the vehicle propulsion system from a vehicle operator 102. For example, controller 190 may receive sensory feedback from pedal position sensor 194 that communicates with pedal 192. Pedal 192 may refer schematically to a friction generator pedal and/or an propulsion foot pedal.

Energy storage device 150 may periodically receive electrical energy from a power source 180 residing external to the vehicle (e.g. not part of the vehicle) as indicated by arrow 184. As a non-limiting example, vehicle propulsion system 100 may be configured as a plug-in hybrid electric vehicle (HEV), whereby electrical energy may be supplied to energy storage device 150 from power source 180 via an electrical energy transmission cable 182. During a recharging operation of energy storage device 150 from power source 180, electrical energy transmission cable 182 may electrically couple energy storage device 150 and power source 180. While the vehicle propulsion system is operated to propel the vehicle, electrical energy transmission cable 182 may be disconnected from power source 180 and the electrical energy storage device 150. Controller 190 may identify and/or control the amount of electrical energy stored at the energy storage device, which may be referred to as the state of charge (state-of-charge or SOC). In some examples, the power source 180 may be another vehicle such as a battery electric vehicle (BEV) in the same fleet, the same parking lot, etc., with the propulsion system 100. For example, the controller 190 include instructions for identifying one or more BEVs that are capable of adding charge to the vehicle propulsion system 100 under conditions where engine start may otherwise occur, e.g., to power vehicle power loads and/or add to battery SOC.

In other embodiments, electrical transmission cable 182 may be omitted, where electrical energy may be received wirelessly at energy storage device 150 from power source 180. For example, energy storage device 150 may receive electrical energy from power source 180 via one or more of electromagnetic induction, radio waves, and electromagnetic resonance. As such, it will be appreciated that any suitable approach may be used for recharging energy storage device 150 from a power source that does not comprise part of the vehicle. In this way, motor 120 may propel the vehicle by utilizing an energy source other than the fuel utilized by engine 110.

Fuel system 140 may periodically receive fuel from a fuel source residing external to the vehicle. As a non-limiting example, vehicle propulsion system 100 may be refueled by receiving fuel via a fuel dispensing device 170 as indicated by arrow 172. In some embodiments, the first fuel tank 144 and the second fuel tank 145 may be configured to store the fuel received from fuel dispensing device 170 until it is supplied to engine 110 for combustion.

This plug-in hybrid electric vehicle, as described with reference to vehicle propulsion system 100, may be configured to utilize a secondary form of energy (e.g. electrical energy) that is periodically received from an energy source that is not otherwise part of the vehicle.

The vehicle propulsion system 100 may also include a message center 196, ambient temperature/humidity sensor 198, and a stability control sensor, such as a lateral and/or longitudinal and/or yaw rate sensor(s) 199. The message center may include indicator light(s) and/or a text-based display in which messages are displayed to an operator, such as a message requesting an operator input to start the engine, as discussed below. The message center may also include various input portions for receiving an operator input, such as buttons, touch screens, voice input/recognition, etc. In an alternative embodiment, the message center may communicate audio messages to the operator without display. One example of a message center may include an in-vehicle infotainment system. Further, the sensor(s) 199 may include a motor speed sensor. These devices may be connected to controller 190. In one example, the control system may adjust engine output and/or a motor output to fulfil a driver torque demand in response to sensor(s) 199.

In some embodiments, controller 190 may identify and/or control the amount of electrical energy stored in energy storage device 150. It may also identify the amount of fuel stored in the first fuel tank 144. The controller 190 may control the vehicle propulsion system 100 based on an electric range, the electric range determined based on one or more of the amount of electrical energy stored in the energy storage device 150, battery capacity, ambient conditions, vehicle load, speed, driver driving style, tire traction, and other operating conditions.

In some examples, controller 190 may include computer readable instructions stored on non-transitory memory that when executed cause the controller to receive route data including a destination and a route and determine a route distance based on the route data. In response to the route distance not exceeding an electric range, the instructions may cause the controller 190 to suppress an operation of the internal combustion engine 110 based on the route data, ambient temperature, and cabin pre-conditioning. In response to the route distance exceeding the electric range, further in anticipation of a fuel station along the route, where the fuel station has a fuel with a carbon footprint less than a low-carbon threshold, the instructions may cause the controller 190 to operate the vehicle in a charge sustaining or charge increasing mode prior to a refueling event at the fuel station. For example, the controller 190 may access a global positioning system (GPS) or an internet-based mapping application, input the destination, and generate a route based on the GPS data. Based on the electrical energy stored in the energy storage device 150, ambient conditions that may affect discharge and/or charge conditions, the route, and other factors, the controller 190 may determine whether the route exceeds the EV range of the vehicle. In one example, based on the determination, and further based on the route, the controller 190 may propose one or more low carbon refueling opportunities to the driver, the one or more opportunities evaluated and ranked based on the carbon footprint, and in some examples, other variables such as deviation from the route, estimated fuel level on arrival, fuel quality, and associated experiences. In some examples, electric vehicle recharging opportunities may be similarly evaluated and ranked based on the carbon footprint and other variables.

In one example, the carbon footprint may be defined as an estimate amount of greenhouse gases emitted the production and use of an energy source, such as a low carbon fuel or source of electricity at a recharging station. In one example, the greenhouse gases may include one or more of carbon dioxide, methane, nitrous oxide, fluorinated gases, and water vapor. The controller 190 may include computer readable instructions stored on non-transitory memory that when executed cause the controller to estimate the carbon footprint of a refueling, recharging, or other potentially emission reducing opportunity based on a well-to-wheel carbon footprint. However, in other examples, additionally, or alternatively, different approaches for calculating emissions may be used such as life cycle assessment, global warming potential, and carbon dioxide equivalency.

In one example, well-to-wheel (WTW) carbon footprint is a term used to describe a measure of the carbon footprint of a vehicle which considers emissions produced upstream from the vehicle, referred to as a well-to-tank carbon footprint, and emissions from vehicle operation, referred to as a tank-to-wheel carbon footprint. Well-to-tank emissions may include, for example, upstream generation of electricity and fuel production, which may emit variable amounts of carbon depending on the generation mode, processing techniques, storage and distribution efficiency, and so on. Tank-to-wheel emissions may include emissions produced during vehicle operation, such as emitted from the tailpipe, which may vary based on vehicle operating conditions such as energy source used to power the vehicle, driver style, vehicle speed, and others. One example calculation for well-to-wheel footprint may include:

$${CF}_{wtw} = {CF}_{wtt} + {CF}_{ttw}$$

where, CF_{wtw} is the well-to-wheel carbon footprint, CF_{wtt} is the well-to-tank carbon footprint (emissions from fuel production and delivery), and CF_{tw} is the tank-to-wheel carbon footprint (emissions from fuel combustion in the vehicle).

By using a comprehensive measurement, such as the well-to-wheel carbon footprint, increased accuracy and flexibility may be integrated into the disclosed systems and methods for PHEV emission reduction. Accuracy may be increased by considering upstream processes that contribute to emissions in addition to the tailpipe emissions. Flexibility may be increased by considering upstream processes, such as regional variations in energy production, which may be accounted for when evaluating recharging and refueling opportunities.

Additionally, or alternatively, the emissions associated with refueling from a source may be collected by a third party. Example programs may include the California low carbon fuel standard (LCFS) and the Argonne National Laboratory's GREET model, which assist fuel providers to estimate the emissions associated with a fuel pathway. Vehicle emissions may be calculated by processors within the vehicle or calculations may be done via cloud computing according to established estimating methods. In some examples, additionally, or alternatively, the carbon footprint may include various other environmental consequences of an energy source. For example, drivers in some regions may prioritize reducing emissions from fuel production, such as greenhouse gases. However, in other regions, land and/or water resource use may be a higher priority, for example, due to drought conditions. To accommodate such conditions, the disclosed systems and methods for PHEV emission reduction may be extended to include other environmental concerns.

FIG. 2. shows a control diagram illustrating a strategy 200 for plug-in hybrid energy management. The strategy 200 determines a power split between an engine and an electric motor based on driver torque demand, battery state of charge (SOC), and battery power closed loop controls. The strategy 200 may be executed by a controller based on instructions stored on a memory of the controller and in conjunction with signals received from sensors of the vehicle propulsion system, such as the sensors described above with reference to FIG. 1. The controller may employ actuators of the vehicle propulsion system to adjust system operation, according to the strategy described below.

The strategy 200 includes a driver torque demand determination at block 202, battery power closed loop controls at block 204 and battery power determination at block 206. The driver torque demand determination at block 202 may include as inputs a driver torque demand and an actual motor speed. In one example, driver torque demand may be determined based on a position of a driver pedal detected by a pedal position sensor, such as the drive pedal 192 and pedal position sensor 194 in FIG. 1. Actual motor speed may be determined based on a motor speed sensor, such as one of sensors 199 in FIG. 1. The driver torque demand determination may output a driver torque demand. In one example, the driver torque demand determination may output a lower torque demand than indicated by the pedal position, for example, a lower torque demand that is calibrated to reduce overall tailpipe emissions. The lower torque demand may be subject to higher priority vehicle system demands. In such an example, further pedal depression may enable an override of the lower torque demand.

The actual motor speed may be multiplied by a gain (e.g., a constant value) at block 208. The output of block 208 may be an adjusted motor speed signal. The adjusted motor speed signal may be multiplied by the driver torque demand at block 210. The output of the block 210 may be a driver power demand.

The battery power determination at block 206 may include as inputs the driver power demand, as determined previously, and battery SOC, as estimated by the control system, e.g., via a battery control module of controller 190. The output of the battery power determination may be a battery power request. In one example, the battery power determination may be based on a look up table with the driver power demand and the battery SOC as inputs. In some examples, a look up table for battery power determination may be tuned based on the charge mode (e.g., CD, CS, etc.) or other values of the control system.

Turning briefly to FIG. 3, a plot 300 illustrating a battery power determination look up table (LUT) is shown. Battery SOC as a percent of a full battery charge is plotted on the x-axis, power demand in Kilowatts is plotted on the y-axis, and battery power in Kilowatts is plotted on the z-axis. The power demand determined at block 210 and the battery SOC estimated by the control system may be input to the LUT to obtain the battery power determination at block 206. For example, a 20 Kw power demand and 80% SOC determines an approximately 20 Kw of battery power request. In some examples, the plot 300, or similar LUTs, may be used for obtaining signals related to running in all-electric mode, such as described in more detail with reference to FIGS. 5A-5B below.

In one example, operating the vehicle in any one of the charge modes may lead to different battery power requests in real time. For example, the CI mode may prioritize battery charging regardless of driver demands while the CS mode may prioritize engine power and driver power demand approximately equally. For this reason, the charge modes may rely on different LUTs, and the output of the LUT (e.g., the z-axis) may be tuned using various optimization methods, such as gradient based or Bayesian optimization.

Returning to FIG. 2, at block 212, the battery power request is subtracted from the driver power demand, and modified by battery power closed loop controls to produce an engine power demand. In a few examples, battery power closed loop controls may include SOC calculation, strategies to maintain battery SOC within a threshold range (e.g., between an upper SOC threshold and a lower SOC threshold), battery contactor control, and battery power allocation control. For example, battery power closed loop controls may clip or modify an engine power demand to maintain an SOC threshold.

FIG. 4 shows an exemplary chart 400 illustrating control modes for plug in hybrid energy management. Time is plotted on the y-axis and battery state of charge on the x-axis. The time may be a duration of vehicle operation. In an example trip, the halfway point of the trip may be represented by dashed line 406. A state of charge upper threshold is indicated by dashed line 404, hereinafter an SOC upper threshold. A state of charge lower threshold is indicated by dashed line 402, hereinafter an SOC lower threshold. In the example, the SOC upper threshold is 0.8 or 80% of a full charge and the SOC lower threshold is 0.3 or 30% of a full charge. However, in other examples, the upper and lower SOC thresholds may be different. In one example, the SOC upper threshold and the SOC lower threshold may comprise an all-electric range of a PHEV, such as the vehicle propulsion system 100. In one example, the all-electric range may be defined as the capacity to operate a vehicle using electric energy stored on the vehicle battery, e.g., without engine power. In one example, the control system may operate the PHEV to increase charge up to the SOC upper threshold and deplete charge down to the SOC lower threshold.

In some examples, the exemplary chart 400, and similar approaches, may be known as a charge depleting and charge sustaining control algorithm as the algorithm may determine when to transition between a charge depleting mode, where vehicle propulsion primarily relies on energy stored in the battery, and a charge sustaining mode, where the internal combustion engine, the electric motor, and the generator may coordinate to fulfil power demand and maintain the battery SOC at a threshold SOC. Conventionally, the PHEV may be operated in charge depleting mode when the battery is at or above a state of charge upper threshold (e.g., dashed line 404), such as at the beginning of a trip, until the battery reduces to a state of charge lower threshold (e.g., dashed line 402). Thereafter, the PHEV may be operated in charge sustaining mode. In contrast with conventional applications, the systems and methods disclosed herein introduce a method to implement the charge sustaining mode at the beginning of the trip, and further, introduce a more aggressive charging increase mode.

Plot line 408 shows an example of charge depleting charge sustaining control. The approach includes operating the PHEV in a charge depleting mode from time zero until the SOC reduces to the state of charge lower threshold indicated by dashed line 402, which in the example occurs as time approaches a threshold time indicated by dashed line 406. After that point, the PHEV engages a charge sustaining mode, where fuel is burnt and methods like regenerative energy recovery are used to maintain the battery level. For example, the engine is operated to maintain electrical power storage within a threshold range of the state of charge lower threshold. The systems and methods disclosed herein include a high-efficiency, charge depleting mode, including prioritizing powering the PHEV with electric energy, and further including suppressing an operation of the engine based on route data, ambient conditions, and cabin pre-conditioning. For example, high-efficiency, charge depleting mode may include overriding drive mode switching requests and other lower-priority functions that may contribute to unintentional engine start and unintentional emissions production. Overriding lower-priority functions may include dimming or turning off unused display screens, adjusting thermal management settings, or reducing the background functions of software applications. Additionally, or alternatively, one approach for reducing unintentional engine on events, may include prompting the driver to confirm an engine engaging (e.g., fuel-using) drive mode choice via an in-vehicle message center such the message center 196 in FIG. 1.

In the event that a low carbon refueling event has been integrated into the vehicles navigation before the drive began, charge sustaining charge depleting control may be implemented. Plot line 410 displays one such implementation. In this case, the drive begins in the charge sustaining mode, wherein the engine is operated to maintain electrical power storage within a first threshold range of the state of charge upper threshold. For example, the first threshold range may be a non-zero positive threshold range, such as, the state of charge upper threshold +/−5%. Other threshold ranges are possible and may be calibrated based on vehicle operating conditions. The charge sustaining mode burns liquid fuel, which can then be replenished with a low carbon during the scheduled refueling event. Overall emissions reduction may be achieved by storing more low carbon fuel that would otherwise be stored if charge depleting charge sustaining control was implemented prior to the low carbon refueling event PHEV. A more aggressive method is represented by plot line 412. As shown by plot line 412, the vehicle begins the drive in a charge increasing mode, wherein the engine is operated to increase electrical power storage above the state of charge upper threshold. The charge increasing mode increases the charge of the vehicle past the SOC upper threshold of 0.8 before the vehicle switches to charge sustaining mode. The charge increasing mode burns liquid fuel, which can be replenished at the anticipated low carbon refueling stop. The vehicle may then switch to high-efficiency, charge depleting mode, and run in that mode for a longer period of time compared to the method displayed by plot line 408. At the final displayed time, the vehicle is also in a higher SOC than either plot line 408 or plot line 410.

Exemplary approaches for controlling the drive mode of a PHEV to reduce emissions are shown in methods 500, 600, and 700, in FIGS. 5A-7 respectively. The method 500 is shown over a first flowchart and a second flowchart, the first flowchart describing an approach for lowering emissions based on route information, selective control of drive modes, and strategic use of recharging and refueling opportunities. The second flowchart of the method 500 shows an approach for locating and suggesting potential recharging and refueling options when a route exceeds an all-electric range of the PHEV. As used herein, the all-electric range of the PHEV, or the capacity to operate the vehicle using electric energy stored on the vehicle battery, e.g., without engine power, is referred to as an EV range. The method 600 is a third flowchart describing an approach for controlling the PHEV to maximize fuel refilling of low carbon fuel options when the route is greater than the EV range of the PHEV. The method 700 is a block diagram describing an exemplary logic for evaluating refueling options and vehicle controls to maximize fuel refilling, such as described in the method 600. Instructions for carrying out the method 500 and the rest of the methods included herein may be executed by a controller based on instructions stored on a memory of the controller and in conjunction with signals received from sensors of the vehicle propulsion system, such as the sensors described above with reference to FIG. 1. The controller may employ actuators of the vehicle propulsion system to adjust system operation, according to the methods described below.

Turning now to FIG. 5A, it shows the method 500 for selective drive mode operation and route planning for emission reduction.

At 502, the method may include determining whether a start or run is indicated. For example, start or run indication may be determined based on a signal from an ignition accessory. If a start or run is not indicated, the method may include looping at 504 until a start or run is indicated.

If a start or run is indicated, the method may include obtaining signals related to running on all-electric mode at 504. In a few examples, the signals may include vehicle operating conditions such as an engine temperature, a fuel level, battery capacity, a battery SOC, global positioning system (GPS) data, vehicle cargo and/or tow weight, ambient conditions, use of vehicle heating/cooling systems, driver profile (e.g., aggressive, conservative, etc.), and so on.

At 506, the method may include determining whether a route is received or determined. In one example, a route may include a destination, such as a GPS coordinate. In another example, the route may include an itinerary, such as a destination, and optionally, intermediate destinations. In one example, the driver may input a destination into an electronic device that is connected to controller 190, such as a phone or tablet that is connected wirelessly to the controller 190. As another example, the driver may input a destination in response to a prompt generated by the controller 190 and displayed to the driver via message center 196. Additionally, or alternatively, the route may be determined based on a high-confidence itinerary prediction.

In one example, itinerary prediction may be based on drive patterns. As a prophetic example, a commuter leaves for work from their home every weekday at 7 AM. The commuter does not input navigation into their vehicle, but often follows the same drive route from their home to their workplace. Under these circumstances, it may be possible for an itinerary prediction system (e.g., stored in the memory of controller 190 in FIG. 1) to predict with high levels of confidence that on a non-holiday weekday, when the driver begins a trip at 7 AM, the driver is driving their vehicle along the same drive route to work (e.g., the typical route). In an alternative embodiment, the vehicle computer systems may integrate an online calendar system such as Google calendar. For example, if a driver has an event stored in their calendar with an associated location, such as tickets for a train at a certain time, the itinerary prediction system may be able to predict that a driver operating their vehicle within a window of time to their train tickets is driving to the train station.

Based on the input destination and/or prediction, a route to the destination may be computed, including a travel distance of the route, and the route input to a navigation system of the vehicle. In one example, the route data may further include information pertaining to emissions controlled areas or times (e.g., green zones). In one example, additionally, or alternatively, the route data may include geographic information such as altitude changes, high traffic areas, low traffic areas, and so on. If the route is not received or determined, the method may continue to 508. At 508, the method may include operating the vehicle in a high efficiency, charge depleting mode until the battery is depleted to a threshold electric vehicle (EV) range. In one example, the high efficiency, charge depleting mode may be similar as described with reference to FIG. 4. For example, the high efficiency, charge depleting mode may include prioritizing electric battery powered driving and suppressing unintentional engine starts. In one example, the threshold EV range may include a non-zero positive value threshold. For example, the threshold EV range may include a percent of a charged battery e.g., 20% of a full charge. As used herein, high efficiency, charge depleting mode may be referred to as CD mode.

At 510, the method may include setting the trip status to driving to the destination. In one example, setting the trip status to driving to destination may occur concurrently while operating the vehicle in CD mode (e.g., for the duration of the route). In some examples, the trip status may be used for coordinating PHEV and BEV charging at the destination and/or along the route.

Returning to 506, in response to receiving or determining the route, at 512 the method may include determining whether the trip status is “driving to destination” and the route distance to the destination is less than or equal to the EV range. For example, the method may include determining a difference between the route distance and an estimated range based on the battery SOC. In some examples, the estimated range may consider driving conditions along the route, such as ambient conditions, geographic features such as altitude changes, traffic, emission-controlled corridors, and so on.

In one example, the trip status may be set to driving to destination when the route distance is within the EV range. For example, under such conditions there may be less value to add a charging or low carbon refueling stop along the way to reduce engine starts. Additionally, or alternatively, the destination may be defined as a location where the vehicle may be plugged in for charging. For example, for drivers without home charging, the method may include suggesting stopping at a grocery store or a coffee shop to plug in when the driver is driving home and there is on charger. The driver may only occasionally take the suggestion, but overall emissions may be reduced compared to the base scenario (e.g., not stopping to charge). Further, the method may include partnerships with stores such as “Get 10% off your grocery purchase if you drop by and plug in on your way home” so then the apartment dweller without access to EV charger both gets more EV range for the drive to work the next day and is happy with the discount on groceries.

If the trip status is driving to destination and the distance to the destination is less than or equal to the current EV range, the method may include operating the PHEV in CD mode until the EV range is equal to the threshold range at 514. In one example, the threshold EV range may be the threshold EV range introduced previously, including for example, a lower SOC threshold that may be represented by a percent of a charged battery e.g., 20% of a full charge.

At 516, the method may include querying electric vehicle charging stations (hereinafter EV charging stations) within a threshold distance of the destination, e.g., input at 506. In one example, querying EV charging stations may occur concurrently while operating the vehicle in CD mode (e.g., for the duration of the route). In one example, additionally, or alternatively, querying EV charging stations may include other mechanisms to replenish the electric battery, such as battery swap. In one example, querying EV charging stations may include one or more of identifying one or more electric vehicle charging stations, determining charger availability at one or more electric vehicle charging stations, and determining charge speed at one or more electric vehicle charging stations. In one example, querying EV charging stations may include one or more of identifying one or more associated experiences in proximity of one or more charging stations. In one example, EV charging stations may be evaluated and ranked based on the carbon footprint of the source of electricity, such as a well-to-wheel carbon footprint, which may be similar to as described above with reference to FIG. 1. For example, the well-to-wheel carbon footprint may include estimating a sum of greenhouse gas emission during production, processing, and delivery of the electricity to the recharging station, and greenhouse gas emission during PHEV operation using the electricity. Additionally, or alternatively, EV charging stations may be evaluated based on other environmental variables, such as land use or water use consequences.

At 518, the method may include determining whether an electric vehicle charging station within a threshold distance from the destination is indicated in 518. In one example, the threshold distance may be a non-zero positive value threshold. For example, the threshold distance may be five miles. In another example, the threshold distance may be two miles, or ten miles, etc. In one example, the threshold distance may be programmable by the driver, or a manager of a vehicle fleet, in another example. For example, the threshold distance may be calibrated to encourage driver opt in. In another example, additionally, or alternatively, the threshold distance may be calibrated to the EV range.

If an EV charging station less than or equal to the threshold distance from the destination is indicated, the method may include updating the destination stored in the vehicle navigation to the EV charger station at 520. In one example, updating the navigation may result in response to driver confirmation. In some examples, one or more EV charging stations within the threshold distance from the destination may be suggested to the driver. For example, the one or more EV charging stations may be presented to the driver via the message center 196. In response to the suggestion, the driver may confirm or disconfirm a desire to update the navigation destination to the EV charger, such as by selecting a button. In other examples, updating the navigation may occur automatically and the driver may select a button to abort. As used herein, button may refer to any type of user input that provides a user a mechanism to select, confirm, or otherwise indicate a choice. The method may end.

If an EV charging station less than or equal to the threshold distance from the destination is not indicated, the method may include maintaining the original navigation instructions at 522. At 524, in response to determining no electric vehicle charging stations within the threshold distance of the destination, the method may include setting the PHEV as available for charging by a compatible battery electric vehicle, such as a BEV including ProPower charging. ProPower charging allows one electric vehicle to transfer charge to another electric vehicle. For example, a PHEV sharing a destination with a BEV may be available to receive a charge from the BEV. For example, under relevant conditions, a compatible BEV and the PHEV may coordinate trip starts for battery charging and cabin pre-conditioning to reduce an engine on event. In this way, PHEV and BEV in a common fleet, sharing a parking lot at an office or apartment building, etc., may coordinate to reduce emissions.

Returning to 512, if the trip status is driving to destination and the distance to the destination is greater than the current EV range, then the method may include determining and suggesting emission reducing opportunities at 526 as further detailed at FIG. 5B of the method 500.

Turning FIG. 5B, at 552, the method may include determining whether the route is less than or equal to an all-electric range threshold, hereinafter a 100% EV range threshold. In other words, the method may include determining whether recharging the PHEV at a charging station along the way to the destination results in a fully electric drive within a threshold route increase (e.g., operating in CD mode). In which case, the method may identify and propose one or more recharging opportunities and associated experiences. In one example, the method may include the controller 190 coordinating with a GPS system, and based on the route, mapping data, and driver preferences, and the 100% EV range threshold, searching the route for a recharging station, including characteristics of the recharging station, such as, carbon footprint of the source of electricity, proximity to a grocery store, a coffee shop, a low carbon fuel station, etc. As a result of the searching, the method may determine one or more options to suggest to the driver to make the trip 100% electric.

The 100% EV range threshold may be a non-zero positive value threshold. In one example, the 100% EV range may be calibrated to suggest a recharging event to the driver in response to determining a recharging event increases the route distance by no more than a threshold route increase. The threshold route may include an additional range wherein the PHEV may remain operating in CD mode for a short period of time, such as, for example, five additional miles, ten additional miles, or some other value past the EV range, which may be calibrated based on conditions of the battery and other parameters An example of extending the route past the EV threshold may include a driver who is driving to their home 22 miles away, but the vehicle battery can only support 20 miles of electric driving. A short charging stop may be suggested to add enough energy to support driving in fully electric mode for the 2 miles the battery was unable to support prior to charging. This strategy would reduce an engine start. In another example, the threshold route may allow battery depleting to 18% charge, or 15% charge, etc., if the driver opts in to adding a recharge stop to make the trip 100% EV. In one example, threshold route may include a drive time that is calibrated to encourage suggestion opt-in, e.g., not too much of a hassle for the driver. Associated experiences may include grocery shopping or getting a coffee while the PHEV charges, and may be suggested to further encourage opt-in. If, at 552, the method determines the route is less than or equal to the 100% EV range threshold, the method may continue to 556. If the route is more than the 100% EV range threshold, the method may continue to 554.

At 554, the method may include determining whether one or more compatible low carbon fuel options are along the route. In one example, a compatible low carbon fuel options may include fuel(s) that match the fuel type used by the PHEV with a carbon footprint less than a low-carbon threshold. In one example, the carbon footprint is an estimate of the total amount of greenhouse gases, particularly carbon dioxide emitted in the production and use of the fuel. In one example, the carbon footprint includes a well-to-wheel carbon footprint, which may be similar to as described above with reference to FIG. 1. For example, the well-to-wheel carbon footprint may include estimating a sum of greenhouse gas emission during production, processing, and delivery of the fuel to the fuel station, and greenhouse gas emission during PHEV operation using the fuel. The low-carbon threshold may be a non-zero, positive value threshold. In one example, the low carbon threshold is a mass of carbon dioxide per volume of fuel, e.g., kg carbon/liter. In one example, additionally, or alternatively, fuel options may be evaluated based on other environmental concerns, such as land use or water use consequences of the fuel type.

Similar to searching for recharging stations, the method may include the controller 190 coordinating with a GPS system, and based on the route and mapping data, searching the route for a low carbon fuel station, including characteristics of the option, such as deviation from the route, estimated fuel level on arrival, price, fuel quality, carbon footprint, etc. As a result of the searching, the method may determine one or more options to suggest to the driver for low carbon refueling. If, at 554, the method determines one or more compatible low carbon fuel stations along the route, the method may continue to 556. If the method determines one or more compatible low carbon fuel stations not along the route, the method may resume at 528 in FIG. 5A. At 528, the method may include setting the trip status to driving to the destination, e.g., the original input destination, and implementing no change in navigation based on refueling options.

If one or more suitable low carbon fueling options are identified along the route, at 556, the method may include proposing one or more fuel stations to the driver. In one example, suggestions may displayed on a display inside the vehicle cabin or another notification system. Suggesting a stop may include ranking the low carbon fueling options at 556a, and proposing a low carbon fuel station based on the rankings 556b. At 556a, the fuel stations may be ranked on criteria such as by carbon footprint, where fuels with the lowest carbon footprints are preferred, resource effectiveness, proximity to the route, estimated fuel level on arrival, and so on. At 556b, the proposed low carbon fuel station may be proposed via a display inside the vehicle cabin or other notification system.

At 558, the method may include determining whether driver opt out of the suggested one or more low carbon fuel options is indicated. For example, the method may include prompting the driver to enter a selection via a touchscreen, button or other interface. In response to an indication of the driver opting out of the fuel station suggestion at 558, the method may resume at 528 in FIG. 5A. In response to determining driver selection of one of the one or more suggested refueling stops is indicated, the method may continue to 560.

At 560, the method may include adjusting the driving mode of the PHEV based on operating conditions. In one example, the PHEV may be controlled in a charge sustaining (CS) mode or a charge increasing (CI) mode, in addition to the previously introduced high efficiency charge depleting (CD) mode, as previously introduced, based on operating conditions. In one example, the CS mode and the CI mode may be similar to the modes described with reference to FIG. 4. For example, the CS mode may include prioritizing engine powered driving to maintain the battery SOC within a threshold range of the threshold upper SOC. The CI mode may include prioritizing internal combustion engine powered driving to increase the battery charge above the threshold upper SOC. Example conditions may include driver selection of a low carbon fuel station, e.g., determined at 558, route conditions, such as absence of an emission control corridor along the determined route, geographic conditions indicating opportunity for energy recovery, and others. Example methods for adjusting the driving mode based on operating conditions is described below with reference to FIGS. 6-7.

At 562, the method may include setting the trip status to driving to fuel station and updating the navigation to direct the driver to the selected fuel station. The navigation may be displayed visually through an in-cabin screen, a phone, through audio directions, and others. In one example, setting the trip status and updating the navigation may occur concurrently with adjusting the driving mode based on operating conditions.

At 564, the method may include determining whether refueling is indicated. As a non-limiting example, a refueling event may be indicated based on monitoring the level of one or both of the first fuel tank 144 and the second fuel tank 145 through the interface between the controller 190 and the fuel system 140. For example, if a fuel level sensor indicates the fuel level in the first fuel tank 144 increases, a refueling event may be indicated. In one example, the method may include continuously monitoring for a refueling event until a refueling event is indicated at 564. In response to the refueling indication, the method may include setting the trip status to driving to destination and updating the navigation at 578. Updating the navigation may include changing the trip navigation destination from the fuel station to the user-input trip destination. From 578, the method 500 may end.

Returning to 552, in response to determining the route distance is less than or equal to the 100% EV range, the method may continue to 566. At 566, the method may include suggesting one or more EV charging opportunities that, if selected, would make the trip 100% electric. In a few non-limiting examples, EV charging opportunities may include charging stations, battery swaps, and BEVs with bi-directional charge capability. In one example, suggestions may be displayed on a display inside the vehicle cabin or another notification system. Suggesting one or more EV charging stops may include ranking the EV charging options at 566a, and proposing one or more EV charging stations based on the rankings 566b. At 566a, the ranking may be based on criteria such as distance from the main route, and customer experience metrics including charge time, wait time, price, associated experiences, driver preferences, and so on. At 566b, the rankings determined at 566a may be used to propose a charging stop to add to the trip. In some examples, the associated experiences may be proposed to the driver with the charger options. The control system may generate messages, including the associated experiences, to encourage the driver to opt in to adding the recharging stop to the trip. In some examples, associated experiences may include rewards for adding the stop, e.g., credit for use in a rewards program.

At 568, the method may include determining whether driver opt out of the one or more EV charging options is indicated. For example, the method may include prompting the driver to enter a selection via a touchscreen, button or other interface. In response to an indication of the driver opting out of the EV charging stop at 568, the method 600 may resume at 528 in FIG. 5A.

If the driver chooses to make the EV charging stop at 568, e.g., opt out not indicated, the method may include operating the vehicle in CD mode until the electric vehicle range is equal to the threshold range at 570. In one example, the CD mode may be the same as described above with reference to FIG. 4 including, for example, prioritizing electric-powered driving, and further, may include suppressing unintentional engine starts. In one example, the PHEV may be controlled in charge sustaining (CS) mode in response the EV range reaching the threshold EV range, such as described above with reference to FIG. 4.

At 572, the method may include setting the trip status to driving to charging station and updating the navigation system to navigate the driver to the selected charging station. The navigation may be displayed visually through an in-cabin screen, a phone, through audio directions, and others. In one example, setting the trip status and updating the navigation may occur concurrently with operating the PHEV in CD mode.

At 574, the method may include determining whether recharging is indicated. In a non-limiting example, determining a recharging indication may be accomplished by a charge level of the energy storage device 150 being reported to the vehicle controller 190. Increasing charge level may be considered a recharging event. In one example, the method monitors for recharging continuously at 574 until a charging event is indicated. In response to a recharging indication, the method may include updating the navigation and setting the trip status to driving to the destination at 576. Updating the navigation may include changing the destination of the navigation from the EV charging station to the original destination input by the driver. From 576, the method 500 may end.

In this way, the disclosed approach reduces overall emissions by controlling the PHEV to prioritize electric-powered driving where possible, and further, by identifying and proposing to the driver opportunities to make a trip 100% electric. When vehicle operating conditions support less than 100% electric-powered operation for a route, the approach includes attempting to identify additional emissions reducing opportunities, such as by searching the route for low emissions fuel stations, proposing the opportunities to the driver, and when a low emission fuel station is added to the itinerary, controlling the PHEV to maximize refueling with low emissions fuel.

As introduced earlier with reference to FIG. 5B, when the EV range of the PHEV is determined to be exhausted along the planned route, the disclosed approach may reduce emissions by searching the route for low carbon fueling options. FIG. 6 shows the method 600 which illustrates one example approach for increasing fuel refilling of low carbon fueling options where such a strategy has the lowest environmental consequences. For example, if CD mode has the lowest environmental consequences but the PHEV is driven on a long trip that surpasses opportunity to add EV range. Under such conditions, the method may include engaging the charge increasing (CI) mode before planned refueling at a low carbon fuel station to make room to add more low carbon fuel. In this way, the disclosed approach goes beyond identifying low carbon fueling opportunities, and uses the route data and vehicle operating conditions to control drive modes for maximal fuel refilling of low carbon fuel. In one example, the method 600 may be a sub-method of the method 500, and may include some or all of the preceding executions described with reference to FIGS. 5A-B. In other examples, the method 600 may be carried out independently of FIGS. 5A-B. In one example, the method 600 may further implement a scenario-based logic, which is described in more detail with reference to FIG. 7.

At 602, the method may include determining whether the route distance is greater than the EV range plus a threshold. In one example, determining whether the route distance is greater than the EV range plus a threshold distance may indicate whether it may be acceptable to add to the planned route a charging opportunity that enables the route to be completed on 100% electric energy. In one example, the determination is based on obtaining signals related to running on all-electric mode and further based on receiving or determining a route, such as described with reference to 504 and 506 in FIG. 5A, respectively. The threshold may be a non-zero positive threshold value, which, in a few examples, may be calibrated based on driver preferences, user data, fleet manager preferences, and so on. In one example, the threshold may be obtained by calibrating may be acceptable to a driver regarding charge time (e.g., inconvenience) added to the trip. For example, if by stopping at a charger for 30 minutes a trip may be made 100% EV, a driver may be compelled to act, especially if the stop benefits the driver. Benefits might include picking up groceries on the way home or stopping by a favorite coffee shop. Alternatively, suggesting the driver add 12 hours of charging to an already 3-hour drive is likely to be unacceptable to most drivers. In one example, the EV range plus a threshold value may be the same as the 100% EV threshold. If the route distance is greater than the EV range plus the threshold value, then at 604 logic from scenarios 1 through scenario 4 may be engaged based on of the route and the conditions of the vehicle, e.g., as determined in FIG. 5. The logic in scenarios 1 through 4 are described in detail below with reference to FIG. 7. If the route distance is less or equal to the EV range plus the threshold value, the method ends.

Following engaging logic from scenarios 1 through 4, upon vehicle arrival at the low carbon fueling destination, the method may include determining if the route distance is greater than the EV range plus a threshold value at 606. The threshold value may be a non-zero positive threshold value, which, in one example, may be calibrated as described above at 602. This comparison may be made by the computer system of the PHEV based on one or more vehicle operating conditions such as the battery SOC, ambient conditions, travel conditions, distance to the destination from the fuel station, and other parameters. If the route distance is not greater than the EV range plus the threshold value, the method may continue to 608. If the route distance is greater than the EV range plus the threshold value, the method may continue to 610. At 608, the method may include engaging logic from scenario 2, which is described in detail below with reference to FIG. 7.

Following engaging logic from scenario 2, or following from determining the route distance is greater than the EV range plus the threshold value, at 610, the method may include determining whether a change in route during the trip is indicated. In one example, determining whether a route change may include comparing the route received or determined at the beginning of the trip with the route the driver has taken the vehicle. The actual path of the vehicle may be determined by a GPS system of the vehicle computing system or a mobile device in electronic communication with the PHEV. In another example, a route change may be determined by comparing the route predicted at the beginning of the trip to the route the driver has taken the vehicle.

If a route change is indicated, the method may include reevaluating the emissions-minimizing strategy at 612. In one example, reevaluating the emissions minimizing strategy may involve assessing the trip to determine whether the trip may be made in a fully electric drive mode, which reduces engine starts. The assessment may include determining whether there are opportunities to add charge and increase all-electric, high-efficiency drive mode operation, reduce engine starts, and add low-carbon fuels, for example, as described with reference to FIGS. 5A-5B. At 614 the method 700 may include determining whether a change in expected fuel consumption for the trip and actual fuel consumption for the trip is greater than a threshold value. In one example, the threshold value may be a non-zero positive threshold value. In one example, the determination may be accomplished by the computing system recording the level of fuel in the fuel tank at various points in the trip to determine the fuel consumption over the course of the trip. Expected levels of fuel consumption may be calculated by the route distance and terrain, expected performance for the type of vehicle and engine, recorded fuel consumption for similar trips, etc. The difference between the expected fuel consumption and actual fuel consumption can then be calculated and compared to the threshold value.

In one example, one or more the threshold values may be calibrated based on local, state, or national emissions policy goals for PHEVs. In another example, vehicle system margins of error may also be taken into account when determining the threshold value. Margins of error may be determined based on engineering design decisions and may account for normal variation in fuel consumption due to limits of predictive systems. Additionally, or alternatively, one or more threshold values may be based on on-road data collection and analysis. For example, threshold values may be adjusted through an over-the-air update and/or calibration update at a vehicle dealership. Such updating may be useful in outlier conditions, for example, in cold temperatures, after a certain number of years in use, or miles driven or hours the engine has spent ignited. The threshold value(s) may be updated to more closely match vehicle operating conditions.

If the difference between expected fuel consumption and actual fuel consumption is less than the threshold value, the method may continue to 616. If the difference between expected fuel consumption and actual fuel consumption is greater than the threshold, the method may include re-evaluating the emissions reduction strategy at 618, such as described at 612, before continuing on to 616 for reporting.

At 616, the method may include recording and sharing the route outcomes. For example, the method may include tracking benefits, adjusting control strategies based on tracked data and trends, applying the data to learning algorithms, and so on. In one example, tracking may include recording fuel usage data, battery usage data, route data, experiences, rewards, and/or offers associated with driver opt in and opt out, vehicle operating conditions associated with driver opt in and opt out, and others. Tracked outcomes and other data may be shared with stakeholders such as, but not limited to, drivers in a fleet, managers of a fleet, public partners, and so on.

Turning to FIG. 7, the method 700 is shown by diagrams including scenarios 1 through 4, which may be implemented for reducing emissions when a route or itinerary includes a low carbon refueling stop. For example, the scenarios 1 through 4 may be implemented on routes that exceed an EV range of a PHEV. The scenarios 1-4 include strategic use of PHEV drive modes based on a vehicle operating conditions, including battery state of charge (SOC), and the route. The PHEV drive modes may include charge depleting (CD) mode, charge sustaining (CS) mode, and a charge increasing mode (CI) mode, which may be the same modes as described previously with reference to FIG. 4. Briefly, CD mode may include prioritizing electric powered driving (e.g., battery charge) including suppressing unintentional engine starts, which depletes the battery charge level to a lower threshold SOC. CS mode may include prioritizing engine (e.g., conventional fuel) powered driving, which maintains the battery charge level around the lower threshold SOC. The CI mode is similar to the CS mode and prioritizes engine powered driving, however the CI mode may be implemented to increase the battery SOC above an upper threshold SOC when the vehicle operating conditions and the route permit.

In one example, a route may include a trip start A at 702 and a destination C at 706. The route may further include a low carbon fuel station B at 704. For example, the low carbon fuel station may be added to the route (e.g., added to the itinerary stored in the navigation system) in response to determining the route from trip start A to destination C is greater than an EV range of the vehicle, and further, in response to determining the route is greater than a 100% EV range threshold, such as described above with reference to FIG. 5A and FIG. 5B in the method 500.

After beginning the trip at 702, the method 700 may include determining the drive mode based on the SOC of the battery at 708. In one example, the PHEV may be operated in CS mode or CI mode depending on whether charge may be added to the battery or not, such as, for example, based on the battery SOC threshold, whether driving conditions are conducive to using energy recovery, or other vehicle operating conditions. Operating the PHEV in one of the CS and the CI modes at 708 uses liquid fuel to propel the vehicle. In one example, the vehicle propulsion system may be controlled in the mode selected at 708 until the vehicle arrives at the low carbon fuel station 704. At the low carbon fuel station 704, an amount of fuel can be added to the fuel tank. The drive from trip start A to low carbon fuel station B results in consumption of alpha quantity of low carbon liquid fuel to add to the fuel tank.

Following fuel refilling at low carbon fuel station B at 704, further emissions reducing opportunities may be evaluated based on scenario 1 at 710 and scenario 2 at 712. For example, scenario 1 may include the vehicle control system determining the remaining route is less than the EV range. Under scenario 1, the control system may operate the vehicle propulsion system in CD mode on the drive from low carbon fuel station B to destination C, as indicated at 711.

Scenario 2 may include the vehicle control system determining the remaining route is greater than or equal to the EV range at 712. Under scenario 2, in response to determining the remaining is greater than or equal to the EV range, the vehicle control system may determine whether the remaining route is greater than the EV range+a threshold value at 713. In one example, the EV range+the threshold value may be the same as the 100% EV range introduced previously. For example, the EV range+the threshold value may be a non-zero positive value threshold calibrated to determine whether the remaining route could be driven with 100% electric power if an EV charging stop is added to the itinerary. In one example, in response to determining the remaining route is less than or equal to the EV range+threshold value, the method may include identifying one or more recharging stations. For example, the vehicle control system may search an area within a threshold proximity of low carbon fuel station B to identify a charging station, a P2P charge from a BEV, and user experiences near the charging options, such as getting lunch or shopping.

The search may be executed by the vehicle control system using a GPS system, mapping data, and/or internet-based searching, including other parameters such as user preferences. The results of the search may be presented to the driver and the driver may either accept or not. If the driver accepts, the stop may be added to the route as a low carbon charge B-EV1 at 714. After recharging at 714, the PHEV may be run in CD mode, as indicated at 716, until the battery power is depleted or until the destination C is reached.

If the route is greater than the EV range plus a threshold, the PHEV may be run in CD mode until the battery power is depleted or until the destination C is reached as described in scenario 1 at 711. Similarly, if the driver does not add a recharging station to the itinerary, the PHEV may be run in CD mode until the battery power is depleted or until the destination C is reached as described in scenario 1 at 711.

In another example, scenario 3 includes a PHEV having two or more fuel storage tanks, as indicated at 718. In one example, a first tank may include a first fuel type, e.g., CNG-biogas, or other gaseous fuel. A second tank may include second fuel type, e.g., E85 or other liquid fuel. The two or more fuel storage tanks may power the PHEV when not operating in CD mode. The route in scenario 3 may include a trip start A at 720 and a destination C at 726.

One or more low carbon fuel stations may be identified and proposed along the route in response to determining the route from trip start A at 720 to destination C at 726 is greater than an EV range of the PHEV, such as described above with reference to FIGS. 5A-B in the method 500. For example, one or more low carbon fuel stations may be added to the itinerary and stored in the navigation system, including a first fuel type station at 722 and a second fuel type station at 724. In one example, the first fuel type is a lower emissions fuel than the second fuel type.

Under scenario 3, priority is given to fuel consumption and refueling opportunities that reduce emissions on the route. On the route to the first fuel type station at 722, the method may include determining the drive mode based on vehicle operating conditions, e.g., CS mode or CI mode, and operating the PHEV in the determined drive mode with the engine powered by the lower emissions fuel type, which in this example is the first fuel type. In one example, the PHEV may be controlled in the mode determined at 728 until a first refueling event comprising the PHEV arrival at the first fuel type station and refueling the first fuel tank with the first fuel at 722. As above with scenarios 1 and 2, operating the PHEV in one of the CS and the CI modes at 728 uses liquid fuel to propel the vehicle. By powering the vehicle with the first fuel type, more of the first fuel type (e.g., the lower emission fuel type) may be added to the first fuel tank upon arrival at the first fuel type station at 722 than would have been added had the first fuel not been used to the power the vehicle. Additionally, initially using the first fuel type to power the vehicle in CS or CI modes either sustains the battery charge or increases it during the trip.

On the route to the second fuel type station at 724, as above, the method may include determining the drive mode based on vehicle operating conditions, e.g., CS mode or CI mode, and operating the PHEV in the determined drive mode with the engine powered by the second fuel type (e.g., the less preferred fuel). In one example, the PHEV may be controlled in the mode determined at 730 until a second refueling event comprising the PHEV arriving at the second fuel type station and refueling the second fuel tank with the second fuel at 724. As above, operating the PHEV in one of the CS and the CI modes at 730 uses liquid fuel to propel the vehicle. By powering the vehicle with the second fuel type, more of the second fuel type may be added to the second fuel tank upon arrival at the second fuel type station at 730 than the amount of the second fuel that would have been added had the second fuel not been used to propel the vehicle. Additionally, using the second fuel type to propel the vehicle in CI or CS further increases or sustains the battery charge on top of what was added from trip start at 720 to arrival at the first fuel type station at 722.

After refueling at 724, the PHEV may be run in CD mode, as indicated at 732, until the battery power is depleted or until the destination C is reached at 726. In another example, if by adding to the route refueling at the first fuel type station, the rest of the trip can leverage that fuel, the second fuel type station may be excluded from the route. In this way, scenario 3 may further reduce emissions on routes that exceed the EV range of the PHEV. As an example, a PHEV may have both a liquid fuel tank and a gaseous fuel tank. If the PHEV is on a road trip and can refuel with a low-carbon liquid fuel for fuel type 1 and then also add biogas-based CNG for fuel type 2, e.g., another low-carbon fuel, then future refueling along the trip with higher-carbon fuels, such as traditional gasoline or fossil-based CNG, may be mitigated because both fuel tanks are full of low carbon fuels.

In another example, scenario 3 may include geographic dependent control of fuel usage. For example, in the case where the PHEV includes two or more fuel tanks where a first fuel of the two fuels has lower emissions, e.g., a bi-fuel CNG/gasoline engine, the preferred fuel may be geographically dependent. For example, if the route includes driving into a region where reducing local tailpipe emissions are a higher priority, such as an urban area, the fuel used to power the engine may switch from the first fuel to the second fuel, e.g., from gasoline to CNG. In another example, in one geographic area may prioritize the reduction of NOx emissions. Fuel type 1 may have a lower-carbon profile overall, but fuel type 2 may have lower NOx emissions. The use of fuel type 2 may be prioritized in that area to meet local NOx reduction goals. In another example, scenario 4, as indicated at 734, includes a trip start A at 736 and a destination C at 738. The route may further include one or more low carbon fueling stations and recharging stations programmed into the navigation, such as described above with reference to scenarios 1 through 3. In one example, scenarios 1 through 4 may operate the PHEV in CI mode or CS mode to prioritize consumption of fuels in anticipation of the one or more low carbon fueling stations along to the route. However, it may be understood, an overall objective of the systems and methods disclosed herein is to reduce emissions on a route or itinerary.

Under scenario 4, if driving conditions are detected between trip start A at 736 and destination C at 738 where engaging the traction battery may reduce emissions, the method may include selectively operating in CD mode to minimize emissions at 740. The PHEV may operate in the CD mode as long as the conditions persist. As one example, the control system may identify a geographic region including greater than threshold energy recovery conditions, such as several miles of downhill driving, where energy recovery (e.g., via wheel to generator coupling) may add energy to an already-full battery. To take advantage of the energy storage opportunity and reduce emissions along the route, the method may include operating the PHEV in CD mode in advance of the downhill driving. For example, the method may include estimating a battery charge that may be gained from the greater than threshold energy recovery conditions during the downhill driving. The PHEV may be operated in CD mode up to the estimated battery charge (e.g., a range gain threshold) in advance of the downhill driving. In another example, areas or times for priority reduction of emissions may be included in control logic (e.g., green zones, emission-controlled areas, and emission-controlled times).

The following scenarios are prophetic examples of the disclosed systems and methods for a PHEV. In one example, the PHEV may be the vehicle propulsion system 100 described with reference to FIG. 1. The PHEV may have a vehicle controller, such as controller 190, which receives data from various vehicle sensors, such as a sensor measuring ambient temperature and a battery charge sensor to monitor SOC of a battery of the PHEV. The PHEV may also receive signals via a communication link with systems equipped for transmitting information, such as a GPS system, an internet connection, or similar. The PHEV in communication with the vehicle controller may execute one or more method based on instructions stored on a memory accessible to the vehicle controller and in conjunction with signals received from the sensors of the PHEV system. In one example, the method may include one or more of the methods 500, 600, and 700 described with reference to FIGS. 5A-7.

In a first example, a driver owns a PHEV including an 11.8 kWh battery that enables shorter, around-town trips. The driver wants to drive the PHEV on a road trip from Dijon to Combloux, a small town near the French Alps and 317 kilometers (km) from Dijon. The PHEV has an all-electric range of 50 km, which is especially constrained on uphill drives. Adding six charging stops at six hours charge per recharge to the road trip could make the trip 100% EV. However, the inconvenience of turning a 3.5 hour road trip into a 40 hour road trip is not desirable to the driver. In this case, there are potential opportunities to further reduce emissions of which the driver may not be aware. Along the route, a fuel station offers a selection of lower-carbon fuels including next-generation ethanol and e-fuels (e.g., synthetic fuels) for a reasonable price, and a meaningfully low well-to-wheel (WTW) footprint relative to other available petrol and E85 stations along the route.

On the day of departure on the road trip, following vehicle start, the control system generates a destination request, which is displayed on display panel of the PHEV (e.g., controller 190 via message center 196). In response, the driver enters the destination, Combloux. Based on vehicle operation conditions, including the all-electric range (e.g., the EV range), the battery SOC, and the route, the control system determines the infeasibility of a 100% electricity powered trip. The control logic prioritizes reducing trip emissions, and therefore, in response to the determination that the route exceeds the EV range, the control system searches for the route for other opportunities to reduce emissions. The searching detects the fuel station with next-generation ethanol and e-fuels (e.g., synthetic fuels) for a reasonable price, a message is displayed to the driver proposing adding the station to the itinerary, and the driver accepts.

With the low carbon fuel station added to the itinerary, the control system adjusts the drive mode based on operating conditions, including engaging logic from scenario 1 as described with reference to the method 700 in FIG. 7. The logic includes prioritizing maximizing the quantity of low carbon fuel that may be added to the fuel tank at the low carbon fuel station, which may be achieved by selectively controlling the drive modes of the PHEV. Based on the battery SOC, the battery capacity, and the route data, control system determines the lowest emissions producing strategy includes operating the PHEV in CI mode for a duration and operating the vehicle in CS mode thereafter until arrival at the low carbon fueling station. The vehicle is controlled in CD mode after refueling, including suppressing unintentional engine starts.

Controlling the PHEV in this way contributes to reducing emissions in a number of ways. As one example, the driver may be unaware of the low carbon refueling opportunity and choose to refuel at station where the fuel has a higher WTW footprint, which would result in no addition of low carbon fuel to the tank. In contrast, the PHEV implementing the disclosed logic searches for low carbon fuel, associated experiences, and proposes the opportunities to the driver including the associated experiences to encourage opt in. As another example, the driver may be aware and intend to stop at the station to take advantage of the low carbon fuel. However, a PHEV having typical control logic, which prioritizes operating in an all-electric mode, uses electricity stored on the battery first before switching to engine powered driving. Under the typical control logic, assuming a full tank at the departure, an amount of low carbon fuel that can be added to the tank is the amount burned from the depletion of the EV range to arrival at the station. In contrast, the PHEV implementing the disclosed control logic, which prioritizes reducing emissions, uses the internal combustion engine to power driving and maintains or increases the stored electricity for use after refueling with low carbon fuel. As a result, the amount of low carbon fuel that is added to the tank is the amount burned from departure to arrival at the station, while all-electric driving is the same or better. Moreover, emissions from the refueling event may allow for lower-carbon driving on average for additional distance relative to typical control strategies. As a further advantage, in some examples, the stored battery energy may enable the driver to not intiate a cold start engine-on event at departure from the low carbon fuel station. In some examples, at departure from the low carbon fueling station, the control logic may further include engaging scenario 2, including searching the area for a recharging opportunity to make the trip 100% EV, as described with reference to the method 700 in FIG. 7. In this way, the driver reduces emissions above and beyond what would be feasible using typical (e.g., status quo) controls, and in a way that is effortless to the driver.

In a second example, a champagne distribution business includes a fleet of PHEVs. The fleet is typically used for driving on site. However, a few times a year, the fleet drives across the country to deliver boxes of champagne directly to customers, as well as make stops to pick up materials, and meet with customers. The EV range of the PHEVs in the fleet is less than the cross country drive, and adding multiple charging stops to the trip could make the trip 100% EV. However, extending the duration of the trip to accommodate multiple charging stops is not practical for the business.

In this case, there are potential opportunities to further reduce emissions of the fleet of which the business may not be aware. As above with the first example, for a fleet of PHEVs implementing the disclosed control logic, the control system may search the route for low carbon fueling opportunities and associated experiences or rewards programs to encourage fleet opt in. With a cross-country trip, there is potentially a sparse network of low carbon stations, and/or heterogeneity of WTW footprint of refueling options. The control system may suggest refueling stops, prioritizing the stations with the lowest WTW footprint. When added to the itinerary, the control system may leverage drive modes to maximize the amount low carbon fuel added to the tank, e.g., operating the PHEVs in CS or CI mode prior to refueling at a low carbon station. Further opportunities include strategic balancing of drive modes to increase low carbon fuel refilling and itinerary-level emissions minimization, including engaging logic from scenario 4 as described with reference to the method 700 in FIG. 7. For example, when route data indicates a hilly area where energy recovery may add battery charge, the control system may selectively switch from CS or CI mode to CD mode in advance, reducing emissions by taking advantage of free energy. Further, recharging opportunities paired with experiences like stopping for lunch may be proposed to the fleet for additional emission reductions. Further, in this example, the fleet includes fuel tanks that store two fuel types, a preferred low carbon fuel and a less preferred fuel, therefore the control logic may prioritize using and refueling with the preferred fuel type.

On the day of departure on the cross-country trip, the control system receives the route from the fleet control center. Based on vehicle operating conditions, including the all-electric range (e.g., the EV range), the battery SOC, and the route, the control system determines the infeasibility of a 100% electricity powered trip. The control logic prioritizes reducing trip emissions, and therefore, in response to the determination that the route exceeds the EV range of PHEVs in the fleet, the control system searches for the route for other opportunities to reduce emissions. The searching detects fuel stations along the route, proposes adding to the itinerary fuel stations prioritized by lowest WTW emissions, and the fleet control center accepts.

With the fuel stations added to the itinerary, the control system adjusts the drive mode based on operating conditions, including engaging logic from scenarios 1, 3, and 4 to maximize the quantity of preferred, low carbon fuel that may be added to the fuel tank at the first fuel station and reduce overall trip emissions. Based on the battery SOC, the battery capacity, and the route data, the control system determines the lowest emissions producing strategy includes operating the fleet in CI mode for a duration using the preferred, low carbon fuel. In advance of the hilly section, switches to CD mode, reducing the charge of the battery to take advantage of energy recovery to add electricity to the battery through the hilly section. After the hilly section is passed, the control system operates the fleet in CS mode until arriving at the first fuel station. The stored battery energy enables the fleet to not initiate a cold start engine-on upon departure from the first fuel station. From the first fuel station to the second fuel station, the control system adjusts the drive mode based on operating conditions to maximize the quantity of less preferred fuel that may be added to the fuel tank at the second fuel station. Based on the battery SOC, the battery capacity, and the route data, the control system determines the lowest emissions producing strategy generally includes operating the fleet in CS mode until arrival at the second fuel station using the less preferred fuel. However, the route includes an emission controlled corridor. Through the corridor, the control system switches to CD mode, prioritizing emissions reduction through the controlled corridor, switches briefly to CI mode after passing the corridor, and thereafter operates in CS mode until arrival at the second fuel station. Electricity is used for propulsion after refueling.

Controlling a fleet of PHEVs in this way contributes to reducing emissions in a number of ways. Similar to the above example, the fleet or fleet control center may be made aware of opportunities for low carbon fueling opportunities, and when added to an itinerary, the fleet may be controlled to increase storage of preferred fuels. Further, the control logic allows the fleet (or a driver) take advantage of foreknowledge of the route to reduce emissions by switching to CD mode in advance of hilly sections, and replenish the charge using energy recovery through the hilly section. Further, the control logic may integrate regional emissions controls into the strategy. In this way, the fleet (or the driver) may reduce emissions above and beyond what would be feasible using typical (e.g., status quo) controls, and in a way that is effortless to the business owner.

In another example, the disclosed systems and methods may include identifying opportunities to increase charge added to a PHEV based on a duration parked and a charger maximum output power compared to a charge capacity of the PHEV. For example, as described with reference to the method 500, EV charging stops may be suggested to a driver when the route is less than a 100% EV range threshold. A likelihood of the driver opting into the proposed EV charging stop may be increased by reducing a perceived inconvenience of the stop. In one example, increasing charge in this way may include dynamically modifying an accepted maximum power input from the EV charger to align with the determined route and experience, given a travel itinerary (or public charging) and charging capacity.

In one example, the method may include a modified battery cell calibration logic in addition to a default battery cell calibration logic. The modified battery cell calibration logic may include accepting higher power at various battery SOC and ambient temperature ratings, where frequency of deviation from the default battery cell calibration logic is controlled based on a nonzero positive value threshold (e.g., calibrated to the battery during testing). In one example, the modified calibration logic may be triggered when conditions of an itinerary indicate a likelihood of the adjustment maximizing emissions reduction. In another example, a lifetime number of occurrences (or magnitude) of deviation from the default battery cell calibration logic, frequency, and magnitude of usage of the modified calibration logic may be tracked relative to the threshold. In one example, the power accepted by the vehicle may be controlled to align with a proposed customer experience, for example, using round numbers such as a proposed 20 minute stop.

For example, a PHEV may typically charge at 3.7 kW and have a charge time for a 14.4 kWh battery of 3.9 hours. If a determined route could be made 100% EV without switching on the engine, under typical controls, the stop would be 3.9 hours. However, by dynamically modifying the accepted maximum power input from the EV charger, the charge duration may be reduced to align with the determined route and experience. For example, the charge duration may be reduced to 30 minutes, or an hour, and the message displayed on the in-vehicle infotainment system may include “Make your itinerary 100% EV by making a grocery store stop for 30 minutes.” In this way, the driver may be more likely to opt in to the recharging opportunity.

As another example, if a PHEV driver has a 20 mile trip to reach home where they have a charger, and only ten miles of all-electric driving remaining of range. Typically, if the PHEV takes 7.7 kW output of charge, the ten mile gap may take an hour to charge. However, implementing the modified battery cell calibration logic may allow the control system to generate more reasonable suggestions. For example, a message displayed on the in-vehicle infotainment system may include “Would you accept to take a 30-minute stop to grab a cup of coffee and make your trip 100% EV?” Such a message might encourage more all-electric trips than longer stops, which may seem inconvenient or not worth the effort.

In another example, additionally, or alternatively, itinerary-based modification of maximum power allowed from an EV charger to may be extended to various powertrain combinations including 100% electric (BEV), extended range electric vehicle (with a small non-EV motor), hydrogen ICE, or hydrogen fuel cell PHEV, etc.

In other examples, the disclosed systems and methods may include suggesting coordinated trip itineraries for emissions reduction. For example, a convenient train, express bus, micro mobility hub, or in-vehicle park-and-ride with EV charging may be suggested for a route to further reduce emissions and increase opt in to a charging opportunity. For example, such an approach may increase flexibility to design trip itineraries that balance convenience with increasing all-electric driving. Emissions benefits for such an approach may include metrics beyond EV miles driven, such as actual travel miles compared to possible travel miles, while functionality may include integrated payment or other services. Such an approach may be particularly useful to PHEV drivers without home charging.

In another example, alternative fuel combinations with electrified vehicles may be market specific. For example, some combinations of fuel and PHEVs may have lower life-cycle emissions than some BEVs in some markets. The disclosed approach may enable identifying clean alternative fuel in addition to EV charging infrastructure, resulting in further emissions reducing opportunities.

As another example, the disclosed approach may enable identifying alternative fuel infrastructure co-located with EV charging. For example, for a hydrogen fuel cell PHEV, the method may include prioritizing refueling at hydrogen stations with higher shares of renewable hydrogen mix. As another example, for a gasoline PHEV, the method may include preferring E15 and e-fuels, when available. As yet another example, for a PHEV that accepts one or more alternative fuels, such as drop-in fuels (e-fuels), flex fuel (E85), bi-fuel (DME/CNG/LPG) or has some dedicated fuel with distinction in pathways among fuel stations and fuel types, relevant low carbons may be prioritized.

The systems and methods disclosed herein describe example conditions under which unintentional engine starts may be suppressed based on route and vehicle data, and strategies for evaluating and suggesting alternative route navigation and drive mode control in anticipation of a low carbon refueling option or a charging station. In this way, by leveraging trip planning information and strategic drive mode control, emissions may be reduced on long trips that exceed an all-electric range of a PHEV, as well as shorter trips that do not exceed the all-electric range. In some examples, increasing the all-electric driving share of PHEVs and reducing overall emissions may increase PHEV eligibility for incentive programs, reduce manufacturer resource burden, and affirm the policymakers' confidence in PHEV benefits and policies. The technical effect of controlling a PHEV to prioritize emissions reduction is reduced greenhouse gas emissions and reduced dependence on fossil fuels.

The disclosure also provides support for a method for a hybrid vehicle, comprising: receiving route data comprising a destination and a route, determining a route distance based on the route data, in response to the route distance not exceeding an electric range, suppressing an operation of an engine based on the route data, ambient temperature, and cabin pre-conditioning, and in response to the route distance exceeding the electric range, further in anticipation of a fuel station along the route, where the fuel station has a fuel with a carbon footprint less than a low-carbon threshold, operating the hybrid vehicle in a charge sustaining mode or charge increasing mode prior to a refueling event at the fuel station. In a first example of the method, the charge sustaining mode comprises operating the engine to maintain electrical power storage within a first threshold range of a state of charge upper threshold. In a second example of the method, optionally including the first example, the charge increasing mode comprises operating the engine to increase electrical power storage above a state of charge upper threshold. In a third example of the method, optionally including one or both of the first and second examples, the method further comprises: proposing one or more fuel stations to a driver, the one or more fuel stations ranked on one or more of deviation from the route, estimated fuel level on arrival, fuel quality, carbon footprint, and associated experiences. In a fourth example of the method, optionally including one or more or each of the first through third examples, the carbon footprint is a well-to-wheel carbon footprint comprising a sum of a well-to-tank carbon footprint and a tank-to-wheel carbon footprint, where the well-to-tank carbon footprint comprises an estimate of greenhouse gas emission during production, processing, and delivery of the fuel to the fuel station, and tank-to-wheel carbon footprint comprises an estimate of greenhouse gas emission during vehicle operation using the fuel. In a fifth example of the method, optionally including one or more or each of the first through fourth examples, the method further comprises: in response to the route distance exceeding the electric range, further in anticipation of an electric vehicle charging station along the route, where recharging at the electric vehicle charging station results in a fully electric drive within a threshold route increase, suggesting navigation to the electric vehicle charging station, suggesting one or more associated experiences within a threshold distance of the electric vehicle charging station, and suppressing the operation of the engine prior to a recharging event at the electric vehicle charging station. In a sixth example of the method, optionally including one or more or each of the first through fifth examples, the method further comprises: in response to the route distance not exceeding the electric range, querying electric vehicle charging stations within a threshold distance of the destination, and in response to determining an electric vehicle charging station within the threshold distance of the destination, updating the destination to the electric vehicle charging station. In a seventh example of the method, optionally including one or more or each of the first through sixth examples, the method further comprises: in response to determining no electric vehicle charging stations within the threshold distance of the destination, setting the hybrid vehicle as available for charging by a compatible battery electric vehicle. In a eighth example of the method, optionally including one or more or each of the first through seventh examples, the querying comprises one or more of identifying one or more electric vehicle charging stations, determining charger availability at one or more electric vehicle charging stations, determining charge speed at one or more electric vehicle charging stations, and identifying one or more associated experiences in proximity of one or more electric vehicle charging stations. In a ninth example of the method, optionally including one or more or each of the first through eighth examples, the method further comprises: in response to the route data indicating a geographic region comprising greater than a threshold energy recovery conditions, operating the hybrid vehicle in a charge depleting mode prior to the geographic region and operating the hybrid vehicle in the charge increasing mode or charge sustaining mode through the geographic region.

The disclosure also provides support for a system, comprising: a plug-in hybrid vehicle comprising an internal combustion engine, an electric motor, and an energy storage device, the plug-in hybrid vehicle configured to selectively operate in a plurality of driving modes, and a controller with computer readable instructions stored on non-transitory memory that when executed cause the controller to: receive route data comprising a destination and a route, determine a route distance based on the route data, in response to the route distance not exceeding an electric range, suppress an operation of the internal combustion engine based on the route data, ambient temperature, and cabin pre-conditioning, and in response to the route distance exceeding the electric range, further in anticipation of a fuel station along the route, where the fuel station has a fuel with a carbon footprint less than a low-carbon threshold, operate the plug-in hybrid vehicle in a charge sustaining mode or a charge increasing mode prior to a refueling event at the fuel station. In a first example of the system the plug-in hybrid vehicle further comprising, a first fuel tank storing a first fuel and a second fuel tank storing a second fuel, where the first fuel comprises a lower emissions fuel than the second fuel, and, the computer readable instructions further comprising: in response to the route distance exceeding the electric range, further in anticipation of a first fuel station comprising the first fuel along the route, operate the plug-in hybrid vehicle in the charge sustaining mode or the charge increasing mode powered by the first fuel prior to a first refueling event at the first fuel station. In a second example of the system, optionally including the first example, the charge sustaining mode comprises operate the internal combustion engine to maintain electrical power storage within a first threshold range of a state of charge upper threshold. In a third example of the system, optionally including one or both of the first and second examples, the charge increasing mode comprises operate the internal combustion engine to increase electrical power storage above a state of charge upper threshold. In a fourth example of the system, optionally including one or more or each of the first through third examples the computer readable instructions further comprising: propose one or more fuel stations to a driver, the one or more fuel stations ranked on one or more of deviation from the route, estimated fuel level on arrival, fuel quality, carbon footprint, and associated experiences.

The disclosure also provides support for a method for a hybrid vehicle, comprising: receiving route data comprising a route and a destination, determining a route distance based on the route data, in response to the route distance not exceeding an electric range, suppressing an operation of an engine based on the route data, ambient temperature, and cabin pre-conditioning, further in anticipation of an electric vehicle charging station along the route, where the electric vehicle charging station is less than a threshold distance from the destination, updating the route to navigate to the electric vehicle charging station prior to the destination, in response to the route distance exceeding the electric range, further in anticipation of a fuel station along the route, where the fuel station has a fuel with a carbon footprint less than a low-carbon threshold, operating the hybrid vehicle in a charge sustaining mode or a charge increasing mode prior to a refueling event at the fuel station, and in response to the route distance exceeding the electric range, further in anticipation of the electric vehicle charging station along the route, where recharging at the electric vehicle charging station results in a fully electric drive within a threshold route increase, suggesting navigation to the electric vehicle charging station, and suppressing the operation of the engine prior to a recharging event at the electric vehicle charging station. In a first example of the method, the charge sustaining mode comprises operating the engine to maintain electrical power storage within a first threshold range of a state of charge upper threshold, and wherein the charge increasing mode comprises operating the engine to increase electrical power storage above a state of charge upper threshold. In a second example of the method, optionally including the first example, the method further comprises: in response to determining no electric vehicle charging stations within the threshold distance of the destination, setting the hybrid vehicle as available for charging by a compatible battery electric vehicle. In a third example of the method, optionally including one or both of the first and second examples, the method further comprises: in response to the route data indicating a geographic region comprising greater than a threshold energy recovery conditions, operating the hybrid vehicle in a charge depleting mode prior to the geographic region and operating the hybrid vehicle in the charge increasing mode or the charge sustaining mode through the geographic region. In a fourth example of the method, optionally including one or more or each of the first through third examples, the method further comprises: recording and sharing route outcomes.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for a hybrid vehicle, comprising:
receiving route data comprising a destination and a route;
determining a route distance based on the route data;
in response to the route distance not exceeding an electric range, suppressing an operation of an engine based on the route data, ambient temperature, and cabin pre-conditioning; and
in response to the route distance exceeding the electric range, further in anticipation of a fuel station along the route, where the fuel station has a fuel with a carbon footprint less than a low-carbon threshold, operating the hybrid vehicle in a charge sustaining mode or charge increasing mode prior to a refueling event at the fuel station.

2. The method of claim 1, wherein the charge sustaining mode comprises operating the engine to maintain electrical power storage within a first threshold range of a state of charge upper threshold.

3. The method of claim 1, wherein the charge increasing mode comprises operating the engine to increase electrical power storage above a state of charge upper threshold.

4. The method of claim 1, further comprising proposing one or more fuel stations to a driver, the one or more fuel stations ranked on one or more of deviation from the route, estimated fuel level on arrival, fuel quality, carbon footprint, and associated experiences.

5. The method of claim 1, wherein the carbon footprint is a well-to-wheel carbon footprint comprising a sum of a well-to-tank carbon footprint and a tank-to-wheel carbon footprint, where the well-to-tank carbon footprint comprises an estimate of greenhouse gas emission during production, processing, and delivery of the fuel to the fuel station, and tank-to-wheel carbon footprint comprises an estimate of greenhouse gas emission during vehicle operation using the fuel.

6. The method of claim 1, further comprising in response to the route distance exceeding the electric range, further in anticipation of an electric vehicle charging station along the route, where recharging at the electric vehicle charging station results in a fully electric drive within a threshold route increase, suggesting navigation to the electric vehicle charging station, suggesting one or more associated experiences within a threshold distance of the electric vehicle charging station, and suppressing the operation of the engine prior to a recharging event at the electric vehicle charging station.

7. The method of claim 1, further comprising in response to the route distance not exceeding the electric range, querying electric vehicle charging stations within a threshold distance of the destination, and in response to determining an electric vehicle charging station within the threshold distance of the destination, updating the destination to the electric vehicle charging station.

8. The method of claim 7, further comprising in response to determining no electric vehicle charging stations within the threshold distance of the destination, setting the hybrid vehicle as available for charging by a compatible battery electric vehicle.

9. The method of claim 7, wherein the querying comprises one or more of identifying one or more electric vehicle charging stations, determining charger availability at one or more electric vehicle charging stations, determining charge speed at one or more electric vehicle charging stations, and identifying one or more associated experiences in proximity of one or more electric vehicle charging stations.

10. The method of claim 1, further comprising in response to the route data indicating a geographic region comprising greater than a threshold energy recovery conditions, operating the hybrid vehicle in a charge depleting mode prior to the geographic region and operating the hybrid vehicle in the charge increasing mode or charge sustaining mode through the geographic region.

11. A system, comprising:
a plug-in hybrid vehicle comprising an internal combustion engine, an electric motor, and an energy storage device, the plug-in hybrid vehicle configured to selectively operate in a plurality of driving modes; and
a controller with computer readable instructions stored on non-transitory memory that when executed cause the controller to:
receive route data comprising a destination and a route;
determine a route distance based on the route data;
in response to the route distance not exceeding an electric range, suppress an operation of the internal combustion engine based on the route data, ambient temperature, and cabin pre-conditioning; and
in response to the route distance exceeding the electric range, further in anticipation of a fuel station along the route, where the fuel station has a fuel with a carbon footprint less than a low-carbon threshold, operate the plug-in hybrid vehicle in a charge sustaining mode or a charge increasing mode prior to a refueling event at the fuel station.

12. The system of claim 11, the plug-in hybrid vehicle further comprising, a first fuel tank storing a first fuel and a second fuel tank storing a second fuel, where the first fuel comprises a lower emissions fuel than the second fuel; and,
the computer readable instructions further comprising:
in response to the route distance exceeding the electric range, further in anticipation of a first fuel station comprising the first fuel along the route, operate the plug-in hybrid vehicle in the charge sustaining mode or the charge increasing mode powered by the first fuel prior to a first refueling event at the first fuel station.

13. The system of claim 11, wherein the charge sustaining mode comprises operate the internal combustion engine to maintain electrical power storage within a first threshold range of a state of charge upper threshold.

14. The system of claim 11, wherein the charge increasing mode comprises operate the internal combustion engine to increase electrical power storage above a state of charge upper threshold.

15. The system of claim 11, the computer readable instructions further comprising:
propose one or more fuel stations to a driver, the one or more fuel stations ranked on one or more of deviation from the route, estimated fuel level on arrival, fuel quality, carbon footprint, and associated experiences.

16. A method for a hybrid vehicle, comprising:
receiving route data comprising a route and a destination;
determining a route distance based on the route data;
in response to the route distance not exceeding an electric range, suppressing an operation of an engine based on the route data, ambient temperature, and cabin pre-conditioning;
further in anticipation of an electric vehicle charging station along the route, where the electric vehicle charging station is less than a threshold distance from the destination, updating the route to navigate to the electric vehicle charging station prior to the destination;
in response to the route distance exceeding the electric range, further in anticipation of a fuel station along the route, where the fuel station has a fuel with a carbon footprint less than a low-carbon threshold, operating the hybrid vehicle in a charge sustaining mode or a charge increasing mode prior to a refueling event at the fuel station; and
in response to the route distance exceeding the electric range, further in anticipation of the electric vehicle charging station along the route, where recharging at the electric vehicle charging station results in a fully electric drive within a threshold route increase, suggesting navigation to the electric vehicle charging station, and suppressing the operation of the engine prior to a recharging event at the electric vehicle charging station.

17. The method of claim 16, wherein the charge sustaining mode comprises operating the engine to maintain electrical power storage within a first threshold range of a state of charge upper threshold, and wherein the charge increasing mode comprises operating the engine to increase electrical power storage above a state of charge upper threshold.

18. The method of claim 16, further comprising in response to determining no electric vehicle charging stations within the threshold distance of the destination, setting the hybrid vehicle as available for charging by a compatible battery electric vehicle.

19. The method of claim 1, further comprising in response to the route data indicating a geographic region comprising greater than a threshold energy recovery conditions, operating the hybrid vehicle in a charge depleting mode prior to the geographic region and operating the hybrid vehicle in the charge increasing mode or the charge sustaining mode through the geographic region.

20. The method of claim 16, further comprising recording and sharing route outcomes.
